(19) United States
(12) Patent Application Publication
(10) Pub. No.: US 2024/0111305 A1
(43) Pub. Date: Apr. 4, 2024

(54) UNMANNED AERIAL VEHICLE EVENT RESPONSE SYSTEM AND METHOD

(71) Applicant: COLORBLIND ENTERPRISES, LLC, Manhattan Beach, CA (US)

(72) Inventor: Cletus Bradley, Manhattan Beach, CA (US)

(21) Appl. No.: 18/534,394

(22) Filed: Dec. 8, 2023

Related U.S. Application Data
(63) Continuation-in-part of application No. 18/241,827, filed on Sep. 1, 2023.
Application No. 18/241,827 is a continuation-in-part of application No. 18/128,985, filed on Mar. 30, 2023.
(60) Provisional application No. 63/352,128, filed on Jun. 14, 2022.
(60) Provisional application No. 63/327,728, filed on Apr. 5, 2022.

(51) Int. Cl. G05D 1/229; B64U 70/93; G05D 1/656; G06Q 50/26; B64U 101/20; B64U 101/31; G05D 105/55; G05D 109/25

(52) U.S. Cl. CPC G05D 1/229; B64U 70/93; G05D 1/656; G06Q 50/265; B64U 2101/20; B64U 2101/31; B64U 2201/20; G05D 2105/55; G05D 2109/254

(57) ABSTRACT

A threat response system including one or more UAVs for protecting a vehicle of an owner. The one or more UAVs may be located in a docking station within a trunk of the vehicle. The threat response system may launch the one or more UAVs in response to detecting an intruder in a vicinity of the vehicle. The threat response system may further classify an occurring event by analyzing data received from the one or more UAVs with a machine learning system trained on data in an event database, with the event database storing one or more predicted events each corresponding to an event where the vehicle is vandalized, broken into, and/or stolen by the intruder. The threat response system may further select one or more UAV response operations from a response plan database to address the occurring event based on the classification of the occurring event.

### CROSS-REFERENCE TO RELATED APPLICATIONS

This application is a continuation-in-part of U.S. patent application Ser. No. 18/241,827, filed on Sep. 1, 2023, which is a continuation-in-part of U.S. patent application Ser. No. 18/128,985, filed on Mar. 30, 2023, which claims the priority to and benefit under 35 U.S.C. § 119(e) of U.S. Provisional Patent Application No. 63/352,128, filed on Jun. 14, 2022, and U.S. Provisional Patent Application No. 63/327,728, filed on Apr. 5, 2022, each of which is hereby incorporated by reference in their entirety as if fully set forth below.

### FIELD

The present disclosure generally relates to security systems and methods that utilize unmanned air vehicles, mobile devices, and artificial intelligence.

### BACKGROUND

In recent years, there has been a significant percent increase in the number of police officers assaulted and even killed in the line of duty. Unfortunately and for reasons unknown, only a small fraction of local law enforcement agencies even track officer misconduct. Regardless, in spite of the steady stream of unfortunate events in recent years related to police-associated citizen fatalities, the general public vastly supports law enforcement agencies. In particular, society at large recognizes the sacrifices that law enforcement personnel make, which are often overlooked and underappreciated. Moreover, police officers are often injured in the line of duty or get sick at the workplace. For example, the severe acute respiratory syndrome coronavirus 2 (SARS-CoV-2) (“COVID-19”) killed more police officers than all other causes combined in 2020. Accordingly, it would be desirous to provide a system to make police officer and citizen safety a priority and reduce incidents of assault (and even fatalities) when law enforcement and citizens interact.

Relatedly, some security systems are known to output an alarm or a notification when an event occurs that requires attention, such as a typical car alarm. The notification can be a loud repetitive noise with the intention to draw attention and to deter a potential threat to the vehicle. However, for those situations where the repetitive noise becomes background noise and is neglected, immediate attention or deterrence wanes and the potential criminal is given the necessary opportunity to commit the crime. The criminal then leaves without a trace or a meaningful way of being identified. Accordingly, it would be desirous to provide a system to reduce the incidence of such threats and facilitate coordination with law enforcement.

It is with respect to these and other considerations that the various embodiments described below are presented.

### SUMMARY

Embodiments of the present disclosure include a method of operating a response system for a vehicle including one or more unmanned aerial vehicles (UAVs) each having a flight controller. The method includes storing, in an event database, a plurality of predicted events each with a corresponding event score, storing, in a response plan database, a plurality of UAV response operations each being associated with, and tailored to address, different predicted events, receiving, by a controller, event type data and event location data defining an occurring event from one or more data feeds associated with sensors of a surveilled area and/or vehicle that is near the occurring event, determining, by the controller, an occurring event score of the occurring event by analyzing the event type data and the event location data and applying a machine learning system to identify one or more salient characteristics and then basing the occurring event score on the identified one or more salient characteristics, the machine learning system having been generated by processing data from the event database, determining, by the controller, whether a match exists between the occurring event score of the occurring event and the event score of one or more predicted events from the event database, selecting, by the controller, based on the match, one or more UAV response operations from the response plan database that will address the particular occurring event, and controlling, by the controller, the UAV flight controller of the one or more UAVs so as to cause said UAVs to implement the determined one or more UAV response operations.

In some aspects, the controller, event database, and/or response plan database are located remotely from the one or more UAVs, the one or more UAVs being configured to communicate wirelessly with the controller, event database, and/or response plan database.

In some aspects, the controller is located within the one or more UAVs, the controller being configured to communicate wirelessly with the event database and response plan database.

In some aspects, one of the plurality of UAV response operations includes launching one or more UAVs from a roof and/or trunk of the vehicle to identify an intruder associated with the occurring event, causing the one or more UAVs to follow and/or distract the intruder, alerting, by the one or more UAVs, one or more persons in a vicinity of the intruder regarding the occurring event and the intruder, and tracking and/or identifying, by the one or more UAVs, a location of a responding officer in the vicinity.

In some aspects, one of the plurality of UAV response operations includes launching one or more UAVs from a roof and/or trunk of the vehicle to identify an intruder associated with the occurring event, instructing, by the one or more UAVs, the intruder to step away from the vehicle, and sending, by the one or more UAVs, an alert to a user device to inform the vehicle owner of the occurring event and giving the owner an option of alerting police.

In some aspects, the alert to a user device includes a text message and/or a video feed.

In some aspects, receiving the event type data and the event location data from the one or more data feeds includes receiving data from one or more sensors installed on the one or more UAVs, the vehicle, and/or the surveilled area, data from the one or more sensors including a data feed of defined by data from one or more social media networks of user devices within a geofence associated with the event dynamically determined based on users with location-aware devices entering or exiting the geofence.

In some aspects, the one or more data feeds from the one or more sensors includes a video feed, an audio data feed, UAV location feed, a smart city component sensor feed, and/or a telemetry feed.

In some aspects, the machine learning system is configured to identify objects commonly used to harm and/or break into vehicles.

In some aspects, the machine learning system is configured to identify weapons.

In some aspects, a method of operating a vehicle protection system comprising one or more unmanned aerial vehicles (UAVs) is disclosed. The method may include detecting, by one or more sensors of a UAV docking station and/or a vehicle, that an intruder has made contact with the vehicle and/or has remained within a vicinity of the vehicle for longer than a predetermined amount of time, launching, from the UAV docking station, one or more UAVs, recording, by the one or more UAVs, the intruder, the recording including video and/or audio data, and transmitting, by the one or more UAVs, the video and/or audio data to a user device of the vehicle's owner.

In some aspects, the one or more UAVs each have a flight controller, and the method further includes storing, in an event database, a plurality of predicted events each with a corresponding event score, the plurality of predicted events each corresponding to an event where the vehicle is vandalized, broken into, and/or stolen by the intruder, storing, in a response plan database, a plurality of UAV response operations each being associated with, and tailored to address, different predicted events, receiving, by a controller, event type data and event location data defining an occurring event near the vehicle from one or more data feeds associated with sensors of the vehicle and/or the one or more UAVs, determining, by the controller, an occurring event score of the occurring event by analyzing the event type data and the event location data and applying a machine learning system to identify one or more salient characteristics and then basing the occurring event score on the identified one or more salient characteristics, the machine learning system having been generated by processing data from the event database, determining, by the controller, whether a match exists between the occurring event score of the occurring event and the event score of one or more predicted events from the event database, selecting, by the controller, based on the match, one or more UAV response operations from the response plan database that will address the particular occurring event, and controlling, by the controller, the flight controller of the one or more UAVs so as to cause the one or more UAVs to implement the determined one or more UAV response operations.

In some aspects, the machine learning system is configured to identify a distance between the intruder and the vehicle, a weapon and/or tool in a hand of the intruder, and/or contact between the intruder and the vehicle by analyzing video data from the one or more UAVs, and the one or more salient characteristics include the distance between the intruder and the vehicle, whether a weapon and/or tool is in the hand of the intruder, and/or whether the intruder made contact with the vehicle.

In some aspects, the docking station is located within a trunk of the vehicle, the docking station is configured to receive energy from the vehicle and to supply energy to the one or more UAVs by charging a battery of the UAVs, and the controller is configured to open the trunk to allow the one or more UAVs to launch from the trunk and to close the trunk after the one or more UAVs are launched from the trunk.

In some aspects, one of the plurality of UAV response operations may include identifying, by the one or more UAVs, the intruder, following, by the one or more UAVs, the intruder, and relaying, to an officer, a location and/or identity of the intruder by transmitting the location and/or identity of the suspect to a hand held device of the officer.

In some aspects, one of the plurality of UAV response operations may include receiving, by the one or more UAVs, a voice sample of the intruder, determining, by the one or more UAVs, whether the voice of the intruder matches a voice of the vehicle's owner by applying a voice recognition machine learning system to compare the voice sample of the intruder to stored voice samples of the vehicle's owner, the voice recognition machine learning system having been generated by processing a plurality of voice samples of the vehicle's owner, and alerting, by the one or more UAVs, the vehicle's owner when the voice of the intruder does not match the voice of the vehicle's owner.

In some aspects, the controller is configured to receive data from the one or more sensors of the one or more UAVs and/or the vehicle, wherein data from the one or more sensors include a video feed, an audio data feed, and/or a UAV location feed.

In some aspects, the controller is configured to transmit the received data from the one or more sensors of the one or more UAVs and/or the vehicle to a police command center to enable officers to remotely view the occurring event.

In some aspects, one of the plurality of UAV response operations may include causing, by the controller, the one or more UAVs to distract the intruder, alerting, by the one or more UAVs, one or more persons in a vicinity of the intruder regarding the occurring event and the intruder, and tracking and/or identifying, by the one or more UAVs, a location of a responding officer in the vicinity.

In some aspects, the method may further include transmitting, by the one or more UAVs, video data of the intruder to a database containing criminal records, receiving, by the one or more UAVs, an indication from the database whether the intruder has criminal records, transmitting, by the one or more UAVs, a photo of the intruder and/or an alert to a user device of the vehicle's owner, the alert detailing the criminal records of the intruder

In some aspects, a method of operating a public protection system including one or more unmanned aerial vehicles (UAVs) is disclosed. The method includes detecting, by one or more sensors of a UAV docking station, that an officer is initiating an arrest and/or other contact with a suspect, launching, from the UAV docking station, one or more UAVs, surveilling and recording, by the one or more UAVs, the arrest and/or other contact with the suspect, the recording including video and/or audio data, transmitting, by the one or more UAVs, the video and/or audio data to non-law enforcement servers.

In some aspects, a plurality of UAV docking stations are located on traffic lights, street lights, and/or police vehicles.

In some aspects, the one or more UAVs each have a flight controller, the method also includes storing, in an event database, a plurality of predicted events each with a corresponding event score, the predicted events being an interaction between police personnel and a suspect, storing, in a response plan database, a plurality of UAV response operations each being associated with, and tailored to address, different predicted events, receiving, by a controller, event type data and event location data defining an occurring event from one or more data feeds associated with sensors installed on the one or more UAVs and/or surveilled area, determining, by the controller, an occurring event score of the occurring event by analyzing the event type data and event location data and applying a machine learning system to identify one or more salient characteristics and then basing the occurring event score on the identified one or more salient characteristics, the machine learning system having been generated by processing data from the event database, determining, by the controller, whether a match exists between the occurring event score of the occurring event and the event score of one or more predicted events from the event database, selecting, by the controller, based on the match, one or more UAV response operations from the response plan database that will address the particular occurring event, and controlling, by the controller, the UAV flight controller of the one or more UAVs so as to cause said UAVs to implement the determined one or more UAV response operations.

In some aspects, one of the plurality of UAV response operations includes identifying, by the one or more UAVs, the suspect and/or potential witnesses, relaying, by the one or more UAVs, to the officer the identities of the suspect and/or potential witnesses.

In some aspects, identifying, by the one or more UAVs, includes the one or more UAVs communicating video and/or audio data associated with the occurring event to the controller, the controller being configured to identify voices and/or faces by analyzing the video and/or audio data.

In some aspects, one of the plurality of UAV response operations includes identifying, by the one or more UAVs, the suspect and/or potential witnesses, following, by the one or more UAVs, the suspect, relaying, to the officer, a location and/or identity of the suspect by transmitting the location and/or identity of the suspect to a hand held device.

In some aspects, one of the plurality of UAV response operations includes alerting, by the one or more UAVs, one or more persons in a vicinity of the occurring event to vacate the area, patrolling, by the one or more UAVs, the vicinity of the occurring event.

In some aspects, the controller is configured to receive data from the one or more sensors of the one or more UAVs and/or surveilled area, wherein data from the one or more sensors include a video feed, an audio data feed, a UAV location feed, a smart city component sensor feed, and a telemetry feed.

In some aspects, the controller is configured to transmit the received data from the one or more sensors of the one or more UAVs and/or surveilled area to a police command center to enable officers to remotely view the occurring event.

In some aspects, the method also includes storing, in a UAV availability database, the location and condition of a plurality of UAVs available for launch from the plurality of UAV docking stations, the UAV availability database being in communication with the controller.

Embodiments of the present disclosure also include a threat response system and method for a vehicle. The system includes a response and alert generator configured to classify an event through artificial intelligence (AI) by analyzing data from one or more data feeds comprising event type data and event location data related to a surveilled area, determine a total score of the event compared to a predetermined threat threshold, and output one or more response operations based on the event classification and the total score of the event. AI may include, but is not limited to, perception, natural language processing, generative AI, deep learning, artificial neural networks, classifications, clustering, and regression algorithms. The system also includes a response plan database configured to store and/or predict, through AI, one or more predetermined action plans operable to direct one or more unmanned aerial vehicle (UAVs) to respond to the event. The system may also include an event database and a controller. The event database is configured to store a plurality of event types predetermined as suitable for a UAV response. The controller can receive data from one or more data feeds associated with an event of the surveilled area, the data including the event type data and event location data. The controller can also classify the event by determining a match between a total score of the event compared with event data of the one or more data feeds and one or more event types in the event database, determine, based on the match, one or more UAV response operations, and cause the one or more UAVs to perform the one or more UAV response operations. AI classifiers and statistical learning methods can be utilized by the controller in order to classify the event. AI statistical learning methods include, but are not limited to, machine learning techniques such as artificial neural networks and deep learning. The AI classifiers and statistical learning methods may be trained using any number of techniques including, but not limited to, supervised learning and unsupervised learning.

In some aspects, the one or more UAV response operations include one or more UAVs launching from a law enforcement vehicle to identify a citizen or a suspect associated with the event, causing the one or more UAVs to follow and/or distract the citizen or the suspect, alerting, by the one or more UAVs, one or more persons in a vicinity of the event regarding the event, and tracking and/or identifying, by the one or more UAVs, a location of a law enforcement officer in the vicinity of the event and/or guide the law enforcement officer to the event and/or the citizen or the suspect.

In some aspects, the UAVs are configured to identify citizens or suspects through AI facial recognition wherein deep learning models are used. The deep learning models can be trained with facial data from private and/or government databases containing facial data. In some aspects, the UAVs are configured to identify citizens or suspects through AI voice recognition wherein deep learning models are used. The deep learning models can be trained with voice data from private and/or government databases containing voice data.

In some aspects, the controller is configured to share the data with a local network based on a determined geolocation calculated from the event location data, and use the local network as an information relay mesh that enhances communication of the one or more UAVs with a command center.

In some aspects, the controller is configured to receive data from one or more sensors installed on one or more UAVs and/or the surveilled area. Data from the one or more sensors may comprise a video feed, an audio data feed, a UAV location feed, a smart city component sensor feed, and/or a telemetry feed. Data from the one or more sensors may comprise a data feed of defined by data from one or more social media networks of user devices within a geofence associated with the event dynamically determined based on users with location-aware devices entering or exiting the geofence.

In some aspects, the controller is configured to receive data from one or more sensors installed on one or more UAVs and/or the surveilled area, wherein data from the one or more sensors comprise a facial recognition data feed.

In some aspects, the controller is configured to analyze event data of the one or more data feeds to determine the match by applying a machine learning system which utilizes AI to identify one or more salient characteristics and apply a predictive score based on the classified event. The machine learning system having been generated by processing data from the one or more data feeds and data from the response plan database and the event plan database.

In some aspects, the machine learning system is configured to identify the one or more salient characteristics and apply a predictive score based on the classified event.

In some aspects, the system includes a database of a plurality of UAVs available for launch from a law enforcement vehicle and/or from one or more fixed city locations in a surrounding area of the surveilled area, and the event database and a flight plan database each store information pertaining to each UAV available for launch.

In some aspects, the controller is configured to receive information pertaining to one or more conditions determining readiness of one or more UAVs of the plurality of UAVs for launch.

In some aspects, the controller, based on the match, is configured to launch a first UAV of the plurality of UAVs to identify an intruder associated with the event, cause a second UAV of the plurality of UAVs to alert one or more persons in a vicinity regarding the event, cause a third UAV to track and identify a location of a law enforcement officer in the vicinity, travel to the law enforcement officer, and/or guide the law enforcement officer to the event and/or the intruder.

In some aspects, the one or more conditions include one or more of available UAV flight times, a charge state of a power source, and/or a UAV tolerance to one or more meteorological conditions.

In some aspects, the controller is configured to select a flight plan from the flight plan database based on the information pertaining to the one or more meteorological conditions, and output the selected flight plan to the one or more UAVs of the plurality of UAVs with determined readiness based on greatest amount of matching of the one or more conditions.

In some aspects, the selected flight plan includes a three-dimensional space defined by lateral and longitudinal distance ranges for one or more altitude ranges.

In some aspects, the controller is configured to receive data from one or more sensors installed on one or more UAVs and/or the surveilled area, including one or more event location data, determine a direction of movement of a suspected intruder based on the received one or more event location data and sensed characteristics of the suspected intruder, determine, from the response plan database, one or more UAV response and flight patterns, according to criteria threat assessment of the suspected intruder, and/or output the selected response plan to a UAV flight control system operable to allow multiple UAVs to navigate to one or more locations of the surveilled area.

In some aspects, the one or more criteria comprises a UAV attendance profile comprising one or more confrontation actions, one or more observation actions, and/or one or more aiding another UAV actions.

In some aspects, the one or more confrontation actions include an action plan directing one or more UAVs to the alert location in collaboration with an onboard UAV controller to oppose the determined direction of movement of the suspected intruder.

In some aspects, the UAV attendance profile includes a flight plan directing one or more UAVs to a location of the surveilled area associated with the one or more alerts to follow a determined direction of movement of the suspected intruder, and the flight plan output to the one or more UAVs includes instructions to deliver, when at or approximate to the location, one or more on-board effects comprising emissions of soundwaves, frequencies in the electro-magnetic spectrum, and reception and onward transmission of data related to the one or more on-board effects.

In some aspects, the controller is configured to receive event related data from one or more sensors installed on one or more UAVs and/or the surveilled area; and transmitting the event related data to one or more non-law tamper-resistant secure enforcement servers.

In some aspects, a method is disclosed for operating a response system for one or more unmanned aerial vehicles (UAVs). The method includes receiving event type data and event location data from data feeds associated with sensors of a surveilled area, classifying an event of the surveilled area by determining a match between a total score of the event compared with event data of the one or more data feeds and one or more event types in the event database, determining, based on the match, one or more UAV response operations from a response plan database configured to store and predict one or more predetermined response actions, and outputting the determined one or more UAV response operations to a UAV flight control system so as to cause one or more UAVs to implement the one or more UAV response operations.

In some aspects, the step of classifying an event of the surveilled area includes feeding event data of the one or more data feeds into an AI model to determine a match.

In some aspects, the step of receiving event type data and event location data from data feeds includes receiving data from one or more sensors installed on the one or more UAVs and/or the surveilled area, data from the one or more sensors comprising a data feed of defined by data from one or more social media networks of user devices within a geofence associated with the event dynamically determined based on users with location-aware devices entering or exiting the geofence.

In some aspects, a threat response system and method for a vehicle is disclosed. The system includes a response and alert generator configured to determine, based on one or more data feeds including event type data and event location data related to a surveilled area of a vehicle, a presence of one or more threats and output one or more alerts based on the determined presence of the one or more threats. The system also includes a response plan database configured to store and/or predict one or more predetermined action plans operable to direct one or more unmanned aerial vehicles (UAVs) to respond to the determined one or more threats directed at the vehicle. The system may also include an event database and a controller. The event database is configured to store a plurality of event types predetermined as suitable for a UAV response. The controller can receive data from the one or more data feeds associated with the surveilled area, the data including the event type data and the event location data, determine a match between event data of the one or more data feeds and one or more event types in the event database, determine, based on the match, one or more UAV threat response operations, and/or cause the one or more UAVs to perform the one or more UAV threat response operations.

In some aspects, the one or more UAV threat response operations include one or more UAVs launching from the vehicle to identify an intruder associated with the one or more threats, causing the one or more UAVs to follow and/or distract the intruder from trying to harm or break into the vehicle, alerting, by the one or more UAVs, one or more persons in a vicinity of the vehicle regarding the determined one or more threats, and tracking and/or identifying, by the one or more UAVs, a location of a police officer in the vicinity and/or guide the police officer to the vehicle and/or the intruder. In some aspects, the UAVs are configured to identify citizens or suspects through AI facial recognition wherein deep learning models are used. The deep learning models can be trained with facial data from private and/or government databases containing facial data. In some aspects, the UAVs are configured to identify citizens or suspects through AI voice recognition wherein deep learning models are used. The deep learning models can be trained with voice data from private and/or government databases containing voice data.

In some aspects, the vehicle is an automobile, a bus, a limousine, an aircraft, a boat, a helicopter, a tractor, a construction vehicle, or a motorcycle.

In some aspects, the vehicle is a state vehicle (e.g., a city vehicle, a police vehicle, a first responder vehicle, an ambulance, a fire engine, a highway patrol office vehicle, etc.).

In some aspects, the controller is configured to share the data with a local network based on a determined geolocation data calculated from the event location data, and use the local network as an information relay mesh that enhances communication of the one or more UAVs with a command center.

In some aspects, the controller is configured to receive data from one or more sensors installed on the one or more UAVs and/or the surveilled area.

In some aspects, data from the one or more sensors include a video data feed.

In some aspects, data from the one or more sensors include an audio data feed.

In some aspects, data from the one or more sensors include an UAV location feed and a telemetry feed.

In some aspects, data from the one or more sensors include a status feed of nearby crowd-sourced mesh.

In some aspects, data from the one or more sensors include a facial recognition data feed for law enforcement use.

In some aspects, the controller is configured to analyze event data of the one or more data feeds to determine the match by applying a machine learning system to identify one or more salient characteristics to event types and apply a score based on the identified event type. The machine learning system having been generated by processing data from the one or more data feeds and data from the response plan database and the event plan database.

In some aspects, the machine learning system is configured to apply AI models to identify the one or more salient characteristics and apply a predictive score based on the classified event.

In some aspects, a database of a plurality of UAVs available for launch from the vehicle and/or in a surrounding area of the surveilled area, and the event database and a flight plan database each store information pertaining to each UAV available for launch.

In some aspects, the controller is configured to receive information pertaining to one or more conditions determining readiness of one or more UAVs of the plurality of UAVs for launch.

In some aspects, the controller, based on the match, is configured to launch a first UAV of the plurality of UAVs to identify an intruder associated with the one or more threats, cause a second UAV of the plurality of UAVs to alert one or more persons in a vicinity regarding the one or more threats, cause a third UAV to track and identify a location of a police officer in the vicinity, travel to the police officer, and/or guide the police officer to the vehicle and/or the intruder.

In some aspects, the one or more conditions include one or more of available UAV flight times, a charge state of a power source, and/or a UAV tolerance to one or more meteorological conditions, wherein an AI model is applied to assign weights to each condition and then predict the preferred combination of conditions based on the match.

In some aspects, the controller is configured to select a flight plan from the flight plan database based on the information pertaining to the one or more conditions; and output the selected flight plan to the one or more UAVs of the plurality of UAVs with determined readiness based on a greatest amount of matching of the one or more conditions.

In some aspects, the selected flight plan includes a three-dimensional space defined by lateral and longitudinal distance ranges for one or more altitude ranges.

In some aspects, the system including a UAV control base positioned in the surveilled area configured as a local control station for the one or more UAVs. The local control station is configured to control navigation of the one or more UAVs and communicate with the controller and one or more of a plurality of UAVs in a three-dimensional space.

In some aspects, the controller is configured to receive, from the UAV base and/or the one or more UAVs, video and/or audio data feeds by way of a cloud-based controller server and/or remote computing device-based controller server.

In some aspects, the controller is configured to receive one or more event location data, determine a direction of movement of a suspected intruder based on the received one or more event location data; determine, from the response plan database, one or more UAV response and flight patterns, according to one or more criteria. The controller may also be configured to output the selected response plan to a UAV flight control system operable to allow multiple UAVs to navigate to an alert location of the surveilled area.

In some aspects, the controller is configured to determine and/or predict the direction of movement of the suspected intruder by feeding an AI model the event location data and data from the one or more sensors.

In some aspects, the one or more criteria includes a UAV attendance profile including one or more confrontation actions, one or more observation actions, and/or one or more aiding another UAV actions.

In some aspects, the controller is configured to determine, from the response plan database, one or more UAV response and flight patterns, according to the one or more criteria.

In some aspects, the one or more confrontation actions include an action plan directing the one or more UAVs to the alert location in collaboration with an onboard UAV controller to oppose the determined and/or predicted direction of movement of the suspected intruder.

In some aspects, the UAV attendance profile includes a flight plan directing the one or more UAVs to a location of the surveilled area associated with the one or more alerts to follow a determined and/or predicted direction of movement of the suspected intruder.

In some aspects, the flight plan output to the one or more UAVs further includes instructions to deliver, when at or approximate to the location, one or more on-board effects including emissions of soundwaves, frequencies in the electro-magnetic spectrum, and reception and onward transmission of data related to the one or more on-board effects.

In some aspects, the flight plan output to the one or more UAVs further includes instructions to retrieve from a police car and to deliver, when at or approximate to the location of the police officers, one or more firearms and/or weapons to the police officers.

In some aspects, the UAV attendance profile includes a collaborative flight plan directing the one or more UAVs to a location of the surveilled area associated with the one or more alerts in either aiding the other UAV or to replace a malfunctioning UAV and connect to a controller of the UAV base.

In some aspects, a method of operating a response system for a vehicle, the response system having one or more UAVs each having a flight controller, is disclosed. The method can include storing, in an event database, a plurality of predicted events each with a corresponding event score, the plurality of predicted events each corresponding to an event where the vehicle is vandalized, broken into, and/or stolen by an intruder, storing, in a response plan database, a plurality of UAV response operations each being associated with, and tailored to address, different predicted events, receiving, by a controller, event type data and event location data defining an occurring event near the vehicle from one or more data feeds associated with sensors of the vehicle and/or the one or more UAVs, determining, by the controller, an occurring event score of the occurring event by analyzing the event type data and the event location data and applying a machine learning system to identify one or more salient characteristics and then basing the occurring event score on the identified one or more salient characteristics, the machine learning system having been generated by processing data from the event database, determining, by the controller, whether a match exists between the occurring event score of the occurring event and the event score of one or more predicted events from the event database, selecting, by the controller, based on the match, one or more UAV response operations from the response plan database that will address the particular occurring event, controlling, by the controller, the flight controller of the one or more UAVs so as to cause the one or more UAVs to implement the determined one or more UAV response operations.

In some aspects, the controller, the event database, and/or the response plan database may be located remotely from the one or more UAVs, with the one or more UAVs being configured to communicate wirelessly with the controller, the event database, and/or the response plan database.

In some aspects, the controller may be located within the one or more UAVs, with the controller being configured to communicate wirelessly with the event database and the response plan database.

In some aspects, one of the plurality of UAV response operations may include launching one or more UAVs from a docking station within a trunk of the vehicle to identify an intruder associated with the occurring event, causing the one or more UAVs to follow and/or distract the intruder, alerting, by the one or more UAVs, one or more persons in a vicinity of the intruder regarding the occurring event and the intruder, and tracking and/or identifying, by the one or more UAVs, a location of a responding officer in the vicinity.

In some aspects, one of the plurality of UAV response operations may include launching one or more UAVs from a docking station within a trunk of the vehicle to identify an intruder associated with the occurring event, instructing, by the one or more UAVs, the intruder to step away from the vehicle, and sending, by the one or more UAVs, an alert to a user device to inform the vehicle's owner of the occurring event and giving the owner an option of alerting police.

In some aspects, the alert to the user device may include a text message and/or a video feed.

In some aspects, receiving the event type data and the event location data from the one or more data feeds may include receiving data from one or more sensors installed on the one or more UAVs, the vehicle, and/or the surveilled area.

In some aspects, one of the plurality of UAV response operations may include launching one or more UAVs from a docking station within a trunk of the vehicle to identify an intruder associated with the occurring event, receiving, by the one or more UAVs, a sample of a voice of the intruder, determining, by the one or more UAVs, whether the voice of the intruder matches a voice of the vehicle's owner by applying a voice recognition machine learning system to compare the voice sample of the intruder to stored voice samples of the vehicle's owner, the voice recognition machine learning system having been generated by processing a plurality of voice samples of the vehicle's owner, and alerting, by the one or more UAVs, the vehicle's owner when the voice of the intruder does not match the voice of the vehicle's owner.

In some aspects, the machine learning system may be configured to identify a distance between the intruder and the vehicle, a weapon and/or tool in a hand of the intruder, and/or contact between the intruder and the vehicle by analyzing video data from the one or more UAVs, and the one or more salient characteristics include the distance between the intruder and the vehicle, whether a weapon and/or tool is in the hand of the intruder, and/or whether the intruder made contact with the vehicle.

In some aspects, the one or more UAVs are located in a docking station within a trunk of the vehicle, the docking station is configured to receive energy from the vehicle and to supply energy to the one or more UAVs by charging a battery of the UAVs, and the controller is configured to open the trunk to allow the one or more UAVs to launch from the trunk and to close the trunk after the one or more UAVs are launched from the trunk.

In some aspects, a method of operating a response system having one or more UAVs is disclosed. The method can include receiving event type data and event location data from data feeds associated with sensors of a surveilled area associated with a vehicle, determining, by applying AI models, a match between the event type and one or more event types in an event database, the event database being configured to store a plurality of event types including one or more UAV event type responses, determining, by applying AI models, based on the match indicating one or more threats at the surveilled area, one or more UAV threat response operations from a response plan database configured to store and predict one or more predetermined response actions, and/or outputting the determined one or more UAV threat response operations to a UAV flight control system so as to cause one or more UAVs to implement the one or more UAV threat response operations.

In some aspects, the one or more UAV threat response operations include launching one or more UAVs from the vehicle to identify an intruder associated with the one or more threats, causing the one or more UAVs to follow and/or distract the intruder from trying to harm or break into the vehicle, alerting, by the one or more UAVs, one or more persons in a vicinity of the vehicle regarding the determined one or more threats, and/or tracking and/or identifying, by the one or more UAVs, a location of a police officer in the vicinity and/or guide the police officer to the vehicle and/or the intruder. In some aspects, the UAVs are configured to identify citizens or suspects through AI facial recognition wherein deep learning models are used. The deep learning models can be trained with facial data from private and/or government databases containing facial data. In some aspects, the UAVs are configured to identify citizens or suspects through AI voice recognition wherein deep learning models are used. The deep learning models can be trained with voice data from private and/or government databases containing voice data.

In some aspects, a non-transitory computer-readable medium storing instructions that, when executed by a processor to perform a method is disclosed. The method can include receiving event type data and event location data from data feeds associated with sensors of a surveilled area associated with a vehicle, determining a match between the event type and one or more event types in an event database, the event database being configured to store a plurality of event types including one or more UAV event type responses, determining, based on the match indicating one or more threats at the surveilled area, one or more UAV threat response operations from a response plan database configured to store and predict one or more predetermined response actions, and/or outputting the determined one or more UAV threat response operations to a UAV flight control system so as to cause the one or more UAVs to implement a flight plan associated with the one or more UAV threat response operations.

In some aspects, the method of the instructions further includes receiving, from a UAV base of the event location and/or the one or more UAVs, video and/or audio data feeds of the data feeds by way of a cloud-based controller server and/or remote computing device-based controller server.

In some aspects, a controller system is disclosed for controlling an unmanned aerial vehicle (UAV), the controller system including at least one memory storing instructions, including AI models, and at least one processor configured to execute the instructions to perform operations. The operations can include any herein disclosed method.

Other aspects and features of the present disclosure will become apparent to those of ordinary skill in the art, upon reviewing the following detailed description in conjunction with the accompanying figures.

### BRIEF DESCRIPTION OF THE FIGURES

The above and further aspects of this disclosure are further discussed with reference to the following description in conjunction with the accompanying drawings, in which like numerals indicate like structural elements and features in various figures. The drawings are not necessarily to scale, emphasis instead being placed upon illustrating principles of the invention. The figures depict one or more implementations of the inventive devices, by way of example only, not by way of limitation.

FIG. 1 is a flowchart illustrating an exemplary method for operating a response system for one or more UAVs where an event at a surveilled area is detected, according to an example embodiment.

FIG. 2A is an illustration of one or more UAVs of an event response system in use in an event between law enforcement and a citizen, according to an example embodiment.

FIG. 2B is a block diagram of an exemplary UAV for use in the system of FIG. 2A in communication with one or more local and/or cloud-based databases, according to an example embodiment.

FIG. 2C is an illustration of one or more UAVs of an event response system where the UAVs are positioned in one or more locations of a city for use in responding to an event, according to an example embodiment.

FIG. 3 is a block diagram of a computing system in communication with exemplary aspects of the disclosure, according to an example embodiment.

FIG. 4 is a block diagram of an exemplary UAV computing system in communication with an example control base and the example cloud-based computing system of FIG. 3, according to an example embodiment.

FIG. 5 is an illustration of a UAV being alerted to a suspected intruder of a surveilled vehicle, according to an example embodiment.

FIG. 6 is a flowchart illustrating an exemplary method for operating a response system for one or more UAVs where a threat at a surveilled area is detected, according to an example embodiment.

FIG. 7 is a flowchart illustrating an exemplary method for operating a controller of a response system for one or more UAVs, according to an example embodiment.

FIG. 8 is a computer architecture diagram showing a general computing system for implementing aspects of the present disclosure, according to an example embodiment.

FIG. 9 is a flowchart illustrating an exemplary method for operating a response system for a vehicle including one or more UAVs, according to an example embodiment.

FIG. 10 is a flowchart illustrating an exemplary method for operating a response system for a vehicle including one or more UAVs, according to an example embodiment.

FIG. 11 is a flowchart illustrating an exemplary method for operating a response system for a vehicle including one or more UAVs, according to an example embodiment.

### DETAILED DESCRIPTION

Throughout this disclosure, certain embodiments are described by way of example in relation to designing, operating, and maintaining a security system including one or more unmanned aerial vehicles (UAVs) for monitoring, identifying and/or responding to a threat at a surveilled area (e.g., a suspected intruder trying to harm or break into a protected vehicle). Some embodiments of the present disclosure will be described more fully hereinafter with reference to the accompanying drawings. This present disclosure may, however, be embodied in many different forms and should not be construed as limited to the embodiments set forth herein.

As used herein, the term “unmanned aerial vehicle” (UAV) may be used interchangeably with a drone or “radio-controlled” (RC) aircraft where appropriate. In some instances, a computing device may be referred to as a mobile device, mobile computing device, a mobile station (MS), terminal, cellular phone, cellular handset, personal digital assistant (PDA), smartphone, wireless phone, organizer, handheld computer, desktop computer, laptop computer, tablet computer, tablet, terminal, display device, or some other like terminology. In other instances, a computing device may be a processor, an electronic control unit (ECU), a controller, a server, or a central processing unit (CPU). In yet other instances, a computing device may be a set of hardware and software components.

In some aspects, this disclosure relates to a system configured to enhance safety of citizens and state officials (e.g., law enforcement officers as well as other first responders). In operation, the system can be configured to enhance safety of citizens who encounter state officials, such as law enforcement personnel. The system can include one or more UAVs that relay information to each other, a central command center, and/or a social media network in a transparent and unbiased format. Each UAV can be equipped with sensors and firmware to assist in relaying salient information of an event to appropriate personnel (e.g., a law enforcement officer who is closest to a site of interest), assess the situation, and safety level assessment (e.g., the type of situation and related safety of an encounter between a citizen and police) as well as notify other citizens and law enforcement officials regarding the event (e.g., via a remote command center, notifications in one or more social media networks, emergency push notifications to devices within a geofence of an area, an alarm and/or LED light patterns, etc.).

In some aspects, the system of this disclosure is also configured to provide a tamper-proof database related to the event. For example, a first portion of the event (e.g., the first ten minutes of an event) captured by system of this disclosure related to an interaction between a citizen and law enforcement personnel can include audio and/or video data stored in a server of a first remote command center (e.g., a center of a command center database) while a second portion of the event (e.g., the second ten minutes of the event) can be stored in a server of a second remote command center. The servers of the remote command centers can be replicated in a central database as well as multiple locations and/or can store different data types, different data sets, and/or the same data in multiple locations so to improve data availability and accessibility, and to improve system resilience and reliability. In turn, the presence of this database enhances the safety of law enforcement personnel and citizens alike. For law enforcement personal, confrontation between law enforcement and citizens is one of their riskier tasks. The system can process data before a potentially confrontational event as well as interface between officers and citizens.

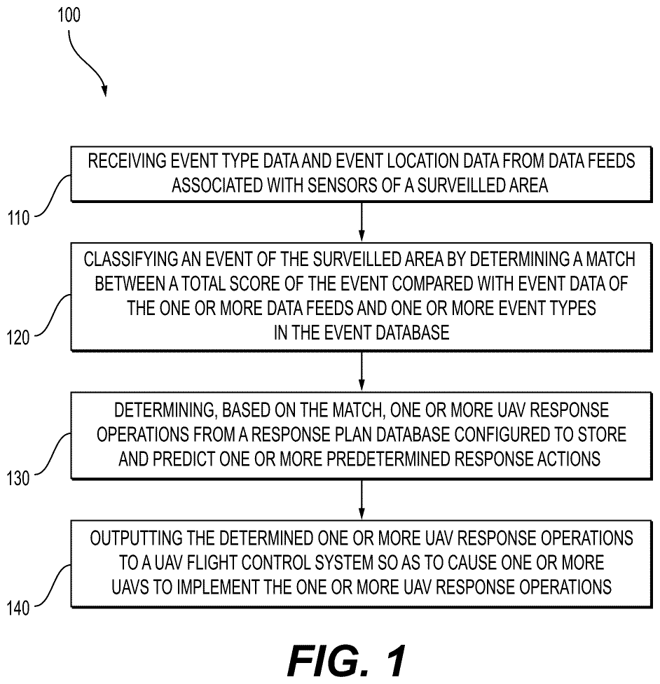

Referring to FIG. 1, a flow diagram of an example method 100 of operating a response system including one or more UAVs is illustrated. In some aspects, each UAV has a flight controller. According to one embodiment, the exemplary method 100 may be implemented by a controller system having memory storing instructions and a processor to execute these instructions to perform operations of method 100 including one or more of the steps of method 100. The method 100 (e.g., steps 110 to 140) may be performed automatically in response to the detected event and/or in response to a request (e.g., from a user). In some aspects, the one or more UAVs of the system can be attached to or otherwise installed with a vehicle (e.g., a state vehicle such as a law enforcement vehicle, an ambulance, a fire response vehicle, a coast guard vehicle, etc., or a private vehicle), whereby the one or more UAVs can include sensors used to detect aspects of an event. In some aspects, such sensors can also be used to predict the threat through artificial intelligence (AI) (e.g., based on historical data prior to it happening and data currently being received). The sensors are able to identify, by utilizing AI models, objects, persons, vehicles, firearms, weapons, etc. The AI models may include, but are not limited to, classifiers, regression models, and statistical/machine learning methods such as artificial neural networks and deep learning. The AI models may be trained using any number of techniques including, but not limited to, supervised learning and unsupervised learning.

In step 110, the method may include receiving event type data and event location data from data feeds associated with sensors of a surveilled area and/or vehicle that is near the occurring event. In some aspects, the event type data and the event location data may be received by a controller. In step 120, the method may include classifying an event of the surveilled area by determining a match between a total score of the event compared with event data of the one or more data feeds and one or more event types in the event database. For example, as soon as an event is detected, one or more UAVs can be immediately launched. In some aspects, the method may also include storing in an event database a plurality of predicted events each with a corresponding event score. The predicted events can be any number of situations emergency responders (e.g., police, firefighters, coast guard, medical personal, etc.) commonly respond to. Each emergency situation will have characteristics common to that scenario. For example, a common situation where police must confront an armed suspect will include characteristics such as the suspect holding some type of weapon. The predicted event may be characterized by an event score, where the event score may be determined by the combination of key characteristics such as, but not limited to, the presence of a weapon. In some aspects, the method may include determining an occurring event score, by the controller, of the occurring event by analyzing the event type data and the event location data and applying a machine learning system to identify one or more salient characteristics and then basing the occurring event score on the identified one or more salient characteristics, the machine learning system having been generated by processing data from the event database. In some aspects, the method may also include determining, by the controller, whether a match exists between the occurring event score of the occurring event and the event score of one or more predicted events from the event database. In some aspects, the step of classifying an event of the surveilled area is by determining, with AI models, a match between a total score of the event compared with event data of the one or more data feeds and one or more event types in the event database. For example, the AI model can be trained to identify objects, such as weapons, and then with image processing techniques, such as deep neural networks, the AI model can identify the objects in the surveilled area. In step 130, the method may include determining, based on the match, one or more UAV response operations from a response plan database configured to store and predict one or more predetermined response actions. In some aspects, the method may also include selecting, by the controller, based on the match, one or more UAV response operations from the response plan database that will address the particular occurring event. In some aspects, the method may also include storing, in a response plan database, a plurality of predicted events each with a corresponding event score. In some aspects, in step 130, AI is utilized in determining, based on the match, one or more UAV response operations from a response plan database configured to store and predict one or more predetermined response actions or a combination of the predetermined response actions. For example, the AI model may have to predict what the optimal UAV response operation is due to event type data and event location data being incomplete. The AI model may predict the optimal UAV response operation based off the probability of various outcomes of the UAV response operations. The AI model having been trained to determine probability of outcomes by being fed data on the outcome of past UAV response operations containing matching event data. In step 140, the method may include outputting the determined one or more UAV response operations to a UAV flight control system so as to cause one or more UAVs to implement the one or more UAV response operations. In some aspects, the method may include outputting the determined one or more UAV response operations to a UAV flight controller so as to cause one or more UAVs to implement the one or more UAV response operations. In some aspects, a controller may control the UAV flight controller and/or the UAV flight control system so as to cause one or more UAVs to implement the one or more UAV response operations. In some aspects, the controller, event database, and/or response plan database may be located remotely from the one or more UAVs, the one or more UAVs may be able to communicate wirelessly with the controller, event database, and/or response plan database. One event type response can include one or more UAVs being launched from the vehicle and/or nearby base in response to detecting the threat. In some aspects, a detected threat event response can include one or more UAVs 270 launching (e.g., from a roof or trunk of the vehicle, and/or from a box within or adjacent to the vehicle). Other event type response operations can include launching a first UAV to identify a suspect associated with the event (e.g., through AI facial recognition) and follow, track, and/or distract the suspect from further conduct, such as continuing a particular crime associated with the event or evading capture. Another UAV response operation includes launching a UAV to similarly alert people in the vicinity of the event (e.g., a neighbor, a bystander, a responding law enforcement officer, etc.) that an event related is happening and to stay away or seek help. In some aspects, the alert is prerecorded such that the particular alert is selected based on the event. In some aspects, the alert is the product of generative AI such that the alert is crafted based on the particular event. Another UAV threat response operation includes launching a third UAV to track and identify the location of a police officer in the vicinity, travel to the police officer, and/or guide the police officer to the vehicle and/or the intruder. All UAVs of the response system can be in communication with each other as well as a central controller to facilitate harm prevention between a responding law enforcement officer and a citizen associated with the event. As used herein, the term “in communication” means direct and/or indirect communication through one or more intermediary components and does not require direct physical (e.g., wired and/or wireless) communication, including selective communication and/or one-time events.

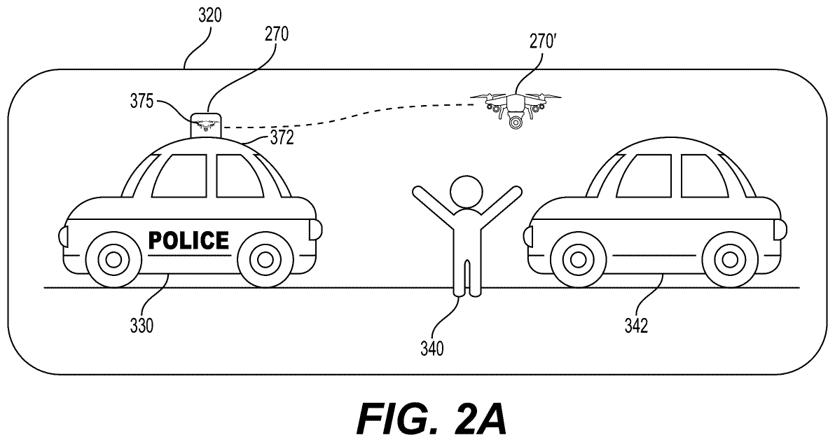

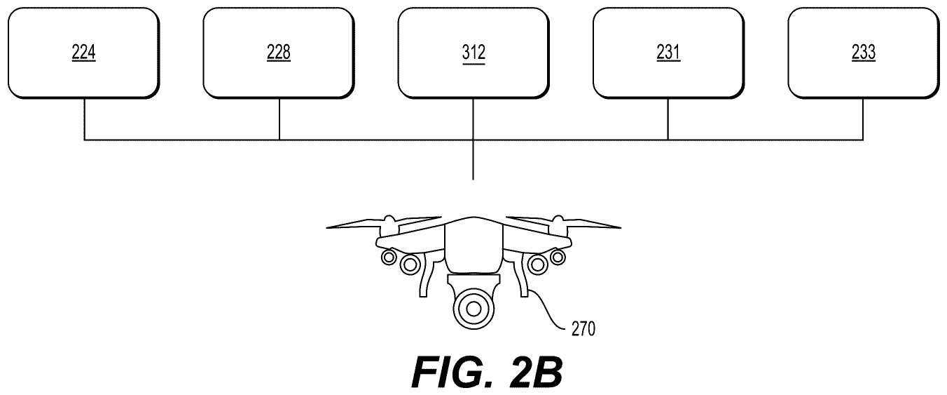

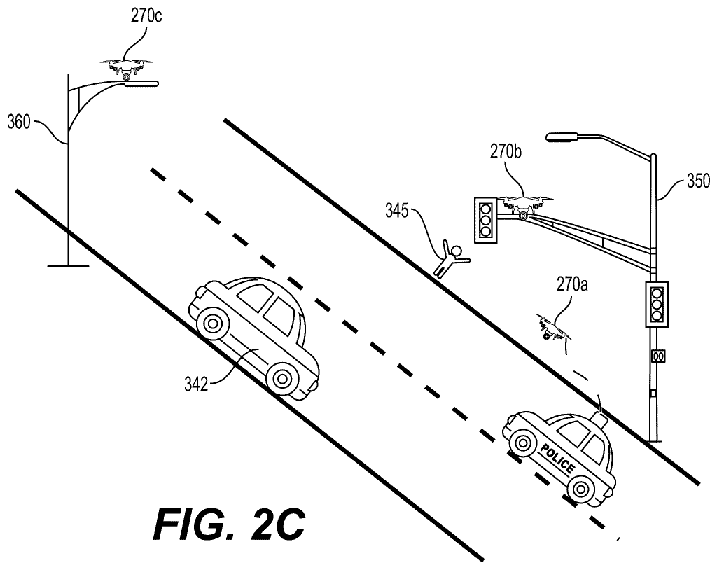

Turning to FIG. 2A, an exemplary schematic is shown with one or more UAVs 270 installed with a law enforcement vehicle 330. In other embodiments the vehicle 330 may be a private vehicle or any other emergency response vehicle, including, but not limited to, an ambulance or firetruck. The one or more UAVs 270 can be launched on demand or automatically in response to instructions from a control center (e.g., in response to determining, through predictive AI models, that an event of interest 320 is occurring such as one between law enforcement 330 and a citizen 340). One or more UAVs 270 being launched from the vehicle 330 can serve as a safety guard for law enforcement officers associated by being present and witnessing event 320 and by relaying real-time information related to event 320 (e.g., to one or more command centers), to one or more users of a social media network (e.g., those users of within the geofence associated with event 320), and/or any server locally or remotely connected thereto. This advantageously provides a system external to and independent of law enforcement's control center; instead, the system creates and maintains one or more event data feeds that can be transmitted to non-law enforcement servers and/or control centers. UAVs 270 can quickly reach and assess emergency situations, providing real-time data to first responders and allowing them to make more informed decisions. In some aspects, such non-law enforcement servers may be incapable of or prevented to share data with law enforcement until authorization is granted by a non-law enforcement entity which ensures that the data is not tampered with or improperly accessed. In some aspects, data tampering protection can be performed by using one or more of blockchain, authentication tokens, digital signatures, tamper resistant protocols, firewalls, and/or the like. Also, by using access controls to protect data in persistent stores to ensure that only authorized users can access and modify the data, and by using role-based security to define which users can view data and which users can modify data.

In one example, when the officer of vehicle 330 pulls over citizen 340 in FIG. 2A, UAV 270 can send a blast alert to citizens in the surrounding area of event 320 (e.g., citizen 340) determined to be in the danger or incident area (e.g., within approximately 1 to 2 mile radius). In some aspects, AI is used to determine how large the incident area is based on the event 320. For example, the AI model can be trained to determine the incident area is larger if a gun is detected versus if no weapons are detected. By utilizing AI, the police can save time by not having to determine the incident area and commanding the UAV 270 during time sensitive events. In some aspects, a corresponding graphical user interface embodying aspects of the response system can be presented in an app on a user device that allows citizens to view and/or listen in real-time to things being seen by UAV 270. Users using the app can view can be alerted when events of interest occur (e.g., that a law enforcement officer has pulled over someone). The alert can include the exact location of the law enforcement officer and any other information to identify aspects or otherwise classify the event 320. The app advantageously provides a level of accountability since users are able to watch and listen to conduct of the law enforcement officer. In observing event 320, interested users are able to travel to event 320 to make sure everything is okay as between the officer and citizen 340.

FIG. 2B depicts an illustration of a block diagram of a response system with exemplary UAV 270 in communication with a plurality of databases, including but not limited to an intelligent recharging database 224, an audiovisual database 228, an autonomous response generator 312 (as discussed below), a networked crowdsource database 231, and a command center database 233. In turn, UAV 270 receives various types of data, information, commands, signals, and the like, from the sensors (e.g., sensors associated with smart city components, vehicles, and other data sources) and subsystems described herein.

The database 224 can include a database of charging locations (e.g., locations within a city such as a docking station or charging receiver positioned in a location such as a street light, a stop sign, a public park, a school, a stadium, etc.) and intelligent charging logic including range, assigned flight operations, and available charge. For example, the database 224 can include logic for determining the estimated consumption for a flight operation of UAV 270, logic for setting a target end point for the energy storage system based upon charge levels of an onboard battery of UAV 270, and logic for determining available charging locations for UAV 270 based upon available response operations and the determined estimated consumption. In some aspects, AI is used to perform probabilistic reasoning when complete information is not present for formal logic. For example, AI models can be used to predict the time length of events and set the estimated battery level requirements accordingly. The AI model can refine its predictions based off the actual amount of battery depletion during an event.

The database 228 can include data feed associated with onboard sensors 476 of UAV 270 as well as data from other audiovisual databases (e.g., audiovisual data feeds from other UAVs 270 as well as data feeds from other users, citizens, law enforcement, and audiovisual “smart city” components, such as remotely connected traffic cameras).

The database 231 can include a database defined by data from one or more social media networks of user devices 240 within a geofence associated with event 320 can be dynamically determined based on users with location-aware devices 240 entering or exiting the geofence. Examples of social media networks for use with database 231 can include Facebook™, Twitter™, Instagram™, TikTok™, LinkedIn™, Pinterest™, Youtube™, SnapChat™, Reddit™, and other present and future social media network systems. Advantageously, the database 231 can be redundant with no single point of failure thereby providing for distributed accountability for individuals involved in event 320 (e.g., the citizen and/or the law enforcement officer).

The database 233 can be a database in communication with one or more command centers for controlling operations of UAV 270. As used herein, the term “in communication” means direct and/or indirect communication through one or more intermediary components and does not require direct physical (e.g., wired and/or wireless) communication, including selective communication and/or one-time events. Command centers associated with the database 233 can be configured to control launch and other flight operations of corresponding UAVs 270.

Once launched from vehicle 330, the one or more UAVs 270 can be used to acquire information about one or more citizens identified related to the event of interest, communicate with the respective citizen (e.g., via push notification to an associated mobile device, by emitting an alert sound and/or LED pattern to the respective citizen and/or law enforcement personnel on scene from the UAV 270), and similarly communicate with other members of a crowd-sourced social media network (e.g., the database 231) within a geofence associated with event 320. As used herein, the term “geofence” means a virtual perimeter of the geographic area associated with the event of interest and can be dynamically generated or match a predefined set of boundaries.

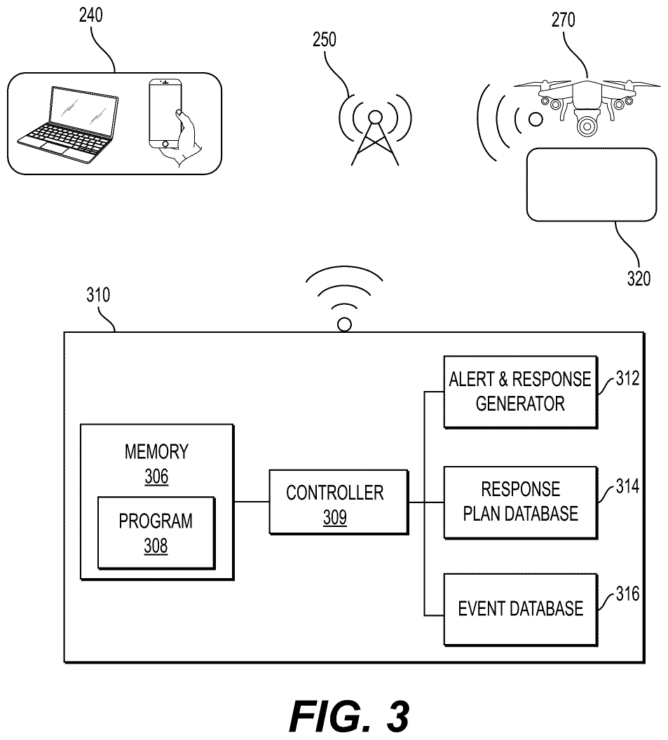

The one or more UAVs 270 can be docked in a docking station 375 on the roof 372 of the vehicle 330 and can autonomously and/or manually be launched therefrom to perform a flight operation (e.g., UAV 270′ which has been launched from vehicle 330) around a stopped citizen vehicle 342 or a citizen 340 without any assistance from the officer of vehicle 330. The docking station 375 may also be positioned within the trunk of vehicle 330. The launched UAV 270′ can perform key tasks autonomously, such as determining, through AI models, objects or events of significance, flying to the determined objects or events of significance and recording information with onboard sensors 476 of UAV 270′ related to event 320 (e.g., audiovisual data, information related to vehicle 342, information related to citizen 340, etc.). The AI models may include, but are not limited to, computer vision techniques such as deep neural networks and recurrent neural networks. The UAV may also perform various functions through AI models by communicating with a response generator 312 (as discussed below). Sensors 476 can include sensors including cameras as well as those configured to measure ambient temperature, cabin temperature, moisture, interior cabin pressure of a vehicle, accelerometers to detect acceleration, telemetry data, location data, etc. Sensors 476 can also include an inertial measurement unit (IMU) having one or more of an accelerometer, a gyroscope, and a magnetometer which may be used to estimate acceleration and speed of UAV 270. Sensors 476 can also include infrared sensors, thermal sensors, LIDAR sensors, GPS sensors, magnetic sensors, current sensors, and the like. Sensors 476 can include wireless transceivers so as to transmit sensor data (e.g. temperature data feeds, moisture data feeds, pressure feeds, accelerometer feeds, telemetry data feed, location data feeds, etc.). In some aspects, sensors 476 can be used to anticipate, by utilizing AI models, a pending threat based on historical data prior to it happening, as discussed more particularly below in FIG. 3. Based on information from the one or more sensors 476, as soon as an initial threat is detected one or more UAVs 270 can be immediately launched. Sensors 476 of UAV 270 can also include one or more cameras with night vision, infrared cameras, microphones, and the like, so as to allow UAV 270 to capture video and provide a live feed and perform threat assessment logic at night or in low light conditions.

In some aspects, LIDAR sensors can provide valuable assistance to UAVs 270 and users, whether the UAVs 270 are integrated into an emergency response system or a security system. For example, LIDAR sensors can assist with obstacle avoidance. LIDAR sensors can create detailed 3D maps of the environment, helping UAVs 270 navigate around obstacles such as buildings, trees, power lines, and/or debris during emergency response missions. In another example, LIDAR sensors can provide accurate mapping. LIDAR can generate high-resolution maps of disaster or accident scenes, providing emergency responders with accurate information about the terrain and potential hazards. In another example, LIDAR can assist with search and rescue. LIDAR-equipped drones can penetrate dense vegetation or areas with limited visibility, allowing them to locate individuals and/or objects that may be hidden from view. In another example, LIDAR sensors can assist with structural assessment. LIDAR sensors can assess the structural integrity of buildings, bridges, and other infrastructure after disasters, helping emergency personnel identify unstable areas and plan rescue efforts accordingly. In another example, LIDAR sensors can provide environmental monitoring. LIDAR sensors can measure changes in ground elevation, water levels, or debris distribution in real-time, aiding in flood assessment, landslide detection, and other natural disasters. In another example, LIDAR can assist with victim detection. LIDAR sensors can help identify survivors and/or casualties in challenging environments by detecting human shapes and movements beneath debris and rubble. In another example, LIDAR sensors can assist with thermal mapping. Combining LIDAR with thermal sensors enables UAV 270 to locate heat signatures, which can be crucial for finding survivors and/or identifying potential fire hazards. This may enable UAVs 270 to provide responders with a detailed map of the scene showing physical features as well as a heat map overlay. In another example, LIDAR sensors can assist with route planning. LIDAR-generated maps can assist in planning efficient routes for emergency vehicles by taking into account the topography and obstacles in the area. In another example, LIDAR sensors can assist with resource allocation. LIDAR sensor data can aid in determining suitable locations for setting up command centers, medical tents, and/or equipment storage based on the terrain and available space. In another example, LIDAR sensors can assist with safety zone establishment. LIDAR sensors can help define safe zones for emergency personnel based on the topography and potential hazards, ensuring responder safety during operations. Incorporating LIDAR technology into UAVs 270 used by emergency vehicles, security systems, and other systems, enhances their ability to operate in challenging conditions, provides accurate spatial data, and improves the effectiveness of search, rescue, and response efforts.

In some aspects, AI can be used in UAVs 270 to assist police and/or emergency service vehicles in various ways. For example, AI-powered systems can analyze real-time traffic data to help vehicles navigate the fastest route to the emergency location. AI-powered systems analyze real-time traffic data by collecting information from various sources, such as GPS data, traffic cameras, road sensors, and sensors 476. These systems use machine learning algorithms to process and analyze this data, identifying traffic patterns, congestion, and road closures. By considering factors like traffic flow, historical data, and real-time updates, AI can determine the fastest route to the emergency location. This information is then communicated to vehicles through navigation apps, allowing them to adjust their routes in real-time to avoid traffic and reach the destination as quickly as possible. UAVs 270 can use AI to determine real-time traffic information by flying ahead and analyzing sensor 476 data such as video data. AI can also assist in predicting high-risk areas and potential incidents, enabling proactive deployment of emergency vehicles. For example, UAVs 270 may analyze sensor 476 data with AI and predict imminent incidents and proactively request emergency vehicles to be sent to the location. Additionally, AI algorithms can process sensor data from vehicles to detect potential hazards, optimize fuel consumption, and enhance overall vehicle performance. These applications can help emergency services respond more effectively and efficiently to critical situations.

In some aspects, UAVs 270 may be configured to use AI to communicate with traffic lights (e.g., city or state owned), being able to change said lights any color to enable faster and safer routes for emergency vehicles. For example, UAVs 270 may fly ahead of emergency vehicles (e.g., a police car, a firetruck, an ambulance, etc.) and communicate with and adjust accordingly any traffic lights along its path to the scene.

In some aspects, the one or more UAVs 270 can be trained to use onboard sensors 476 (e.g., onboard camera) to capture license plate information related to vehicle 342 as well as capture facial recognition data associated with any related citizens 340, potential hazards and navigating through or around obstacles of event 320 (e.g., trees, other oncoming objects such as vehicles or approaching citizens, spaces such as allies between structures, etc.). For example, UAV 270 can be configured to launch from vehicle 330 and arrive near vehicle 342, hover thereabout at roughly the same altitude as a law enforcement officer's head, and scan interiors of vehicle 342 (e.g., through the vehicle windows). UAV 270 can also scan interiors of vehicle 342 and analyze aspects of the dashboard for any weapons, illegal substances, and/or products that can harm or injure the officer as well as citizen 340.

In some aspects, a computer of vehicle 330 is in communication with UAV 270′ while in flight and can receive real-time data. When the UAV 270 launches from vehicle 330, the event 320 is classified and based on a total score and match between event 320 and corresponding response operation, an optimum flight path is predicted and/or determined. UAV 270 is launched as an in-flight UAV 270′ flying towards citizen 340 and/or vehicle 342 while avoiding traffic and other obstructions. During operation, UAV 270′ is configured to relay sensed information related to event 320 to the officer of vehicle 330 even before the officer needs to vacate vehicle 330 and potentially confront citizen 340. By providing event-related information prior to the officer having to personally interact with citizen 340 and thus minimizing unnecessary bias by either party, the likelihood of danger between the officer and individual is reduced. In some aspects, upon arriving at vehicle 342, UAV 270′ can emit sounds (e.g., emitting audio declaring that the UAV 270′ is there as a protector of citizen 340) and/or other citizen perceptible output (e.g., blinking lights of one or more colors, etc.). The UAV 270′ can notify those related to event 320 regarding aspects related to its flight operations, including that it is presently or will initiate recording event 320 and will notify other citizens within the geofence of event 320. The UAV 270′ may further announce that it will relay information sensed by sensors 476 to one or more remote servers and/or remote command centers.

In some aspects, sensors 476 of UAV 270′ can be configured to receive instructional input from citizen 340. For example, citizen 340 can call out to UAV 270′ that further help is necessary or to initiate audio-visual recording and/or transmission to external servers. In some aspects, the sensors 476 of UAV 270′ can be configured to utilize AI through natural language processing when receiving the instructional input. For example, citizen's 340 vocal instructions can be fed into the AI model that can then convert the input into a response operation, such as UAV 270′ retrieving an officer or relaying the citizen's 340 message. In some aspects, citizen 340 can also have one or more system actuators configured to transmit a distress signal so as to notify additional authorities, the nearby UAVs, and other citizens with the mobile device application of the dangerous situation. Upon receiving the distress signal, one or more UAVs are dispatched to the device of citizen 340 or any other device (e.g., any other remotely connected user device 240) that sent the SOS signal.

In one embodiment, UAV 270′ of FIG. 2A is aware of a location of a law enforcement officer (e.g., the law enforcement officer associated with vehicle 330) by an RF ID tag or other device attached to the officer. In one example operation, UAV 270′ travels ahead of vehicle 330 and/or the related officer and uses sensors 476 to assess the area surrounding vehicle 330, by utilizing AI, for obstacles or other potentially dangerous activities or situations (e.g., suspects, active shooters, guns, bombs, explosives, dangerous objects, etc.). For example, AI models can be trained to detect the obstacles or other potentially dangerous activities or situations. UAV 270′ can scan the ground as well as any nearby structures (e.g., buildings and balconies up above) for threats. In some aspects, UAV 270 can launch from vehicle 330 and travel approximately several city blocks ahead of vehicle 300 (e.g., approximately 400 m to 500 m) to perform threat assessment logic, secure the premises, and/or notify the officer of any potential dangers related to event 320 associated by performing event assessment logic and/or threat assessment logic. Example threat assessment logic can include analyzing data, with AI models, from onboard sensors 476 as well as any remotely connected devices (e.g., “smart” city components), classifying the analyzed data according to an event type, and determining, by utilizing AI models, an event assessment based on the classified event type. The term “smart” as used herein is intended to mean mounted sensors and/or detectors that collect and/or generate data and/or other data detailing or associated with aspects such as movement and behavior of people, vehicles, and the like. Such smart devices can be configured to broadcast the sensed data to one or more other devices, such as to vehicles within an area, other infrastructure components, remote servers, or other computing device devices of state authorities (e.g., law enforcement, fire response, ambulance drivers, dispatchers, other city personnel), drivers, pedestrians, cyclists, and/or the like. In operation, if the determined event assessment exceeds a predetermined threat threshold according to the event type, the UAV 270 can carry out one or more threat response operations.

Threat response operations can include causing one or more alerts to be transmitted to computing devices within a geofence of the ongoing event 320 as well as system users, responding officers, and other first responders, with a threat description (e.g., the type of threat, the location, timing information, as well as providing access to real-time data associated with event). Threat response operations can also include transmitting data mined by UAV 270 to the officer and alert the officer regarding the threat assessment. Threat response operations can also include causing, based on the threat assessment, UAV 270 to follow one or more suspects identified with the ongoing event 320. Where UAV 270 assesses that multiple suspects are present, UAV 270 can further assess, through AI models, which of the suspects presents the greatest threat (e.g., the suspect with a firearm or having the most ammunition, etc.) and based on the suspect threat assessment, following the suspect determined to present the greatest threat. In those instances where multiple suspects are assessed, UAV 270 can coordinate with one or more additional UAVs 270 (e.g., via database 233) so that other suspects headed in a different direction can be tracked to the extent possible.

As shown in FIG. 2C, UAVs 270a, 270b, 270c can also be located or positioned with or near city infrastructure. For example, UAV 270a can be positioned with vehicle 330 while UAV 270b can be nested and/or docked with traffic lights 350 and UAV 270c can be nested and/or docked with street lights 360. While not shown, other UAVs 270 can be positioned with stop signs, city parks, public schools, airports, bridges, power lines, factories, power plants, shipping facilities, stadiums, public venues, etc. City infrastructure near or positioned with UAVs 270 can also charge UAV internal power supplies (e.g., onboard direct current batteries). For example, UAVs 270 may be configured to use pre-existing police monitoring systems (e.g., cameras) already in use throughout cities, towns, and states as charging and/or resting stations. The police monitoring systems may be solar powered and may charge the UAVs 270 with the solar generated power. The UAVs 270 may also be charged by solar powered charging ports created and spread throughout cities and/or states. Solar charging technology helps ensure that even during power outages, UAVs 270 can remain operational. In addition, solar technology promotes clean energy which has benefits such as cleaner air for cities and less electricity costs. Solar technology may also be integrated into the UAVs 270 themselves in such a way as to allow the UAVs 270 to effectively charge themselves. In operation, UAV 270b from a first piece of infrastructure (e.g., traffic light 350) can coordinate with UAV 270c from a second piece of infrastructure (e.g., light 360) to assist if the circumstances dictate, to launch if one UAV is running low on charge or requires assistance, etc. Multiple other UAVs can be dispatched to assist the UAVs that are in flight. The decision whether to launch other UAVs may be made autonomously through the use of AI models. The AI models can be trained when to determine that another UAV should be launched to assist based off particular circumstances perceived by various sensors 476 and or infrastructure computing devices in order to avoid the cost and complexity of constant human oversight. UAVs 270 may be configured to use AI in communicating with each other about charging and intersection UAV interchanging from one location to another. In addition, AI may be used in communications between the UAVs 270, command centers, and hard drives, downloading and/or uploading accumulated information gathered.

In some aspects, UAVs 270a, 270b, 270c of FIG. 2C can also be in communication with infrastructure computing devices such as one or more of a city's remote servers and other smart infrastructure components such as smart traffic signals, smart traffic lights, smart toll booths, smart school signals, smart city signals, embedded sensors within roadways or bridges, and/or additional sensors in vehicles. In some aspects, a first UAV 270a can be launched from vehicle 342 (while vehicle 342 is moving or parked) in a response flight operation to identify an event of interest. For example, UAV 270a can be launched towards a citizen 345 and/or vehicle 342 to further identify through AI either (e.g., through facial recognition, license plate recognition, graphic comparison to identify make/model of vehicle 342, etc.) and to follow, track, and/or distract citizen 345 and/or vehicle 342 from further action (e.g., by emitting distracting audio such as a siren or a message announcing that peace officers have been notified, by flashing one or more LEDs, etc.). A second UAV 270b can be simultaneously launched from traffic light 350 in another response operation to similarly alert people in the vicinity (e.g., a neighbor, a bystander, a police officer, etc.), that a crime or some harmful event is happening and to stay away or seek help. A third UAV 270c be simultaneously launched from light 360 in another response operation to track and identify the location of a police officer in the vicinity, travel to the police officer, and/or guide the police officer to the event of interest and/or a suspected intruder. In some aspects, all UAVs 270a, 270b, 270c can be in communications with one another to help assist in preventing the harm from happening to people and property and to direct officials as needed.

In some aspects, all UAVs 270a, 270b, 270c can be in communications with one another and/or infrastructure computing devices to assist in AI decision making. For example, all UAVs 270a, 270b, 270c can communicate to each other data generated by their respective sensors 476. Data from sensors 476 of UAV 270a can be fed into an AI model wherein the output can be in how large of a vicinity must UAV 270b warn people. The AI model can be trained to output a larger vicinity when certain weapons are detected and a smaller vicinity when the event 320 is under control and/or no weapons are detected. The AI model can be trained to recognize numerous other factors that would lead to a larger vicinity and factors that would lead to a smaller vicinity.

In some aspects, the sounds and/or lights emitted, if any, from UAVs of this system can depend on the respective state vehicle it is supporting. For example, UAVs used in law enforcement applications can include sirens as well as emit light patterns similar to a typical law enforcement vehicle. While aspects of the system shown in FIGS. 2A to 2C have been discussed using the example of a law enforcement officer, the solution of this disclosure is not so limited. In some aspects, the system can be implemented with other state vehicles such as ambulances, fire response vehicles, coast guard vehicles, and the like. While the surveillance target vehicle 260 is shown as an automobile, other vehicles can be used for use with the herein disclosed solution. Other example vehicles can also include armored vehicles for banks, commercial vehicles (e.g., e.g., bus, limousine, etc.), an aircraft (e.g., a personal aircraft such as those made by the Cessna Aircraft Company), a commercial aircraft, a boat, a helicopter, farm-related vehicles (e.g., tractor, cargo all-terrain vehicles), construction vehicles (e.g., dump truck, excavator, digger, etc.), motorcycles, as well as any other vehicle generally known in the art. In each specific example, corresponding UAVs can be color coded for the associated use. For example, UAVs used with law enforcement can be blue, UAVs used with ambulances can be red-yellow, UAVs used with fire response can be red, and UAVs used with coast guard can be red-yellow and blue on top. The provided color schemes are merely exemplary and any number of color combinations can be used depending on the application with respective state vehicles.

In some aspects, the response system may be configured to assist with Amber Alerts and missing persons. For example, as soon as an Amber Alert is sent out by authorities, UAVs 270 nearest the area in question may be launched to search for the missing child. UAV 270 may find a missing child and/or missing person by utilizing facial recognition technology to identify the missing child and/or missing person. The UAV 270 may also find and/or identify any suspects that may be involved. AI may be used to predict how the child, person, and/or suspect looks currently if the only available photos are old.

In those examples where the response system is used with an ambulance, UAV 270 can include a navigation system with an ambulance location module configured to track the ambulance destination. Based on this information, UAV 270 can launch and travel ahead of the ambulance to clear the roads of other vehicles so the ambulance can travel to the emergency location more safely and faster. Similar to other examples of this disclosure, UAV 270 can be configured to emit an alert sound (e.g., siren that matches a siren of the ambulance) and/or LED pattern (e.g., the flashing pattern that matches an ambulance) and can travel at a high speed to travel to intersections and stop signs so drivers can see UAV 270 and be alerted of the approaching ambulance. In some aspects, UAV 270 can include at least four sides with LED lights on all sides. In this example, UAV 270 can function as a multi-sided traffic light where each side is configured to cycle through green, yellow, and red depending on the traffic flow and direction and/or destination of ambulance.

In those examples where the response system is used with a fire response vehicle (e.g., a fire engine), UAV 270 can include flame resistant materials (e.g., flame resistant plastics) around the UAV housing as well as flight surfaces such as the propeller blades. In this example, UAV 270 can also include a fire extinguisher and other system for removing oxygen from the air so as to quickly put out a burning fire. UAV 270 can also be equipped with onboard infrared sensors and animal and/or human detection AI logic so as to detect presence of humans and/or pets within a burning structure. Upon detecting presence of humans and/or pets within the burning structure, UAV 270 can alert fire response officers as to specific location of the detected victims, number of victims, and other aspects thereof so that responding officers can be equipped to provide all necessary aid.

In those examples where the response system is used with coast guard vehicles, UAV 270 can be configured with obstacle assessment AI logic that can identify and locate obstacles such as sharks, whales, alligators, crocodiles, etc. Once located, UAV 270 can fly directly over the identified obstacle close to the water and sound an alarm and/or flashing lights to alert those about the identified obstacle. UAV 270 can also be configured to direct a beam of light toward the water to follow the identified obstacle. UAV 270 can continue tracking the identified obstacle so that people in the water can determine where the identified obstacle is going.

In those examples where the response system is used in various emergency vehicles, integrating UAVs 270 and AI into the vehicles can provide comprehensive support in emergency response situations. For firefighters, AI has the potential to greatly enhance firetruck and traffic management. For example, AI can help optimize routes for firetrucks by analyzing real-time traffic data and identifying the fastest and safest paths. AI can also predict traffic congestion, accidents, and road closures, allowing fire departments to make informed decisions. Additionally, AI-powered cameras and sensors of UAVs 270 and/or the surveilled area can monitor intersections and detect potential traffic violations, contributing to safer road conditions. Incorporating AI into UAVs 270 can significantly aid firefighters and rescue operations. AI-equipped UAVs 270 can provide real-time aerial views of the affected area, helping firefighters assess the situation, locate trapped individuals, and plan their approach more effectively. UAVs 270 can also use AI to detect heat signatures (e.g., through a combination of analyzing video and other sensor data), identifying potential survivors or areas with higher risks of fire spread. Moreover, UAVs 270 can relay crucial data back to the firefighters, enabling them to make more informed decisions without directly entering dangerous zones. This combination of AI and UAVs 270 enhances both the safety and efficiency of firefighting and rescue operations.

In those examples where the response system is used in various emergency vehicles (e.g., police cars, firetrucks, ambulances, etc.), AI and UAV 270 integration (e.g., integrating AI into an onboard controller of the UAV 270, system 310, and/or base 280) can bring numerous benefits to the vehicles and responders. For example, AI can provide route optimization by analyzing real-time traffic data and emergency call locations to suggest the fastest and safest routes for emergency vehicles, helping them reach their destinations more efficiently. In another example, AI can assist in rapid scene assessment. UAVs 270 can be dispatched from emergency vehicles to quickly assess the situation from the air, providing real-time visuals and data to responders. AI can be used to recognize the scene and provide the assessment to responders. For example, AI can be trained to recognize various scenarios, and can then classify a scenario by analyzing video and or audio data from the scene. In another example, AI can provide enhanced situational awareness. UAVs 270 can offer an aerial perspective, helping responders understand the extent of an incident, potential hazards, and the location of victims or survivors. In another example, AI can assist with remote communication relay. UAVs 270 can act as communication relays in areas with poor connectivity, enabling seamless communication between responders and command centers. In another example, AI can assist with resource allocation. UAVs 270 equipped with AI can assist in determining the type and number of resources required at the scene, aiding in efficient deployment and coordination. In another example, AI can assist with search and rescue. UAVs 270 equipped with AI can help locate missing individuals or survivors in challenging terrain, such as collapsed builder or remote areas. For example, by analyzing video and/or audio data taken by UAVs 270, AI can be trained to spot survivors. In another example, AI can assist with hazard detection. UAVs 270 can identify hazardous materials or environmental dangers, providing responders with crucial information to plan their approach safely. In another example, AI can assist with supply delivery. UAVs 270 can deliver medical supplies, equipment, or essentials to remote or inaccessible locations, aiding in stabilizing situations before responders arrive. AI can be trained to recognize what types of supplies are needed based off the type of situation, the AI can also be trained to recognize different types of emergency situations. In another example, AI can assist with documentation and reporting. UAVs can capture high-quality images and videos of a scene, helping document evidence for investigations and incident analysis. AI can be trained to recognize how large of an area likely contains evidence. In another example, AI can assist with public safety announcements. UAVs 270 can broadcast important safety information and/or evacuation instructions to a larger area, ensuring public awareness during emergencies. AI can be trained to recognize when certain safety information is pertinent such that UAVs 270 are able to autonomously spread safety information in response to an emergency situation. In another example, AI can provide predictive analytics by analyzing historical data and current trends. AI can predict potential emergency hotspots, allowing emergency services to pre-position vehicles in high-risk areas and reduce response times. In another example, AI can assist paramedics with patient triage in assessing patients' conditions by analyzing their vital signs and symptoms, helping them prioritize and provide appropriate medical care. For example, UAVs 270 can use AI and thermal imaging to take patient's temperature, prompt the patients to say their blood type, and collect other vital signs and symptoms. UAVs 270 may also then take a photo of the patient and relate the assessment to the photo, in order to avoid confusion later. In another example, AI can provide remote consultation. Through video and communication technologies, AI can enable remote medical experts to guide paramedics in critical situations, providing expert advice and improving patient outcomes. For example, when responding to an emergency situation, the AI can recognize that it is a critical situation where a higher level of medical expertise is likely required. Based off this prediction, the UAV 270 may initiate contact with local hospitals and communicate data, such as video and audio data, to the hospital and/or specialist so that their consultation can be relayed to the paramedic in the field. In another example, AI can provide resource allocation. AI can monitor ambulance and patient demand in real-time, helping dispatchers allocate resources effectively to handle emergencies across the region. In another example, similar to firetrucks, AI can help manage traffic to clear the way for ambulances, ensuring they encounter minimal delays during emergencies. In another example, AI can assist in health record access. AI can provide paramedics and other emergency personnel with access to a patient's relevant health records, allergies, and medical history, enabling them to make more informed treatment decisions. In another example, AI can be integrated with automatic external defibrillators (AEDs) to analyze heart rhythms and provide instructions for administering shocks, improving the chances of successful resuscitation. In another example, AI can enhance communications. AI-powered language translation can facilitate communication between paramedics and patients who speak different languages, ensuring accurate information exchange. For example, natural language algorithms and generative AI may facilitate communication between a citizen and emergency responders. Overall, AI can enhance emergency response capabilities, improve patient care, and optimize the resources and processes associated with ambulances, firetrucks, and other emergency vehicles. By integrating UAV 270 and AI technology into various emergency vehicles, responders can benefit from enhanced information, improved coordination, and quicker decision-making, ultimately leading to more effective and efficient emergency responses.

In those examples where the response system is used in various emergency vehicles, such as ambulances, AI and UAV 270 integration (e.g., integrating AI into an onboard controller of the UAV 270, system 310, and/or base 280) can bring numerous benefits to the vehicles and responders. For example, AI can provide rapid assessment of scenes. AI-equipped UAVs 270 can quickly survey emergency scenes, providing real-time visual and other information to paramedics before they arrive. This information can help paramedics assess the situation, the number of patients, and the required resources. In another example, AI can assist with remote triage. UAVs 270 with AI capabilities can conduct initial patient assessments by analyzing vital signs and relaying this data to paramedics. This aids in prioritizing patients and preparing the necessary medical equipment. In another example, AI can provide aerial mapping. UAVs 270 can create detailed aerial maps of the scene, identifying safe entry points, hazards, and obstacles, allowing paramedics to plan their approach more effectively. In another example, AI can assist with emergency supply delivery. UAVs 270 can transport medical supplies, such as defibrillators, medications, or first aid kits, to the scene quickly, especially in challenging terrains or traffic-congested areas. AI may be utilized to predict what supplies will be needed and how quickly. In another example, AI can assist with a communication bridge. UAVs 270 can act as communication relays between remote medical experts and paramedics on the ground, enabling real-time guidance for complex medical procedures. AI may be used to predict when expert guidance will be needed and alter nearby hospitals so that an expert can be located quickly. In another example, AI can assist in traffic management. AI-powered UAVs can help manage traffic around the scene, guiding emergency vehicles and clearing the way for ambulances to reach the location faster. In another example, AI can assist with search and rescue. UAVs 270 can help locate missing individuals or victims in challenging environments, providing precise coordinates for rescue teams. In another example, AI can assist with situational awareness. UAVs 270 with AI can provide a comprehensive view of the scene and recognizing situations, aiding decision making by providing paramedics with insights they might not otherwise have had. In another example, AI can assist with privacy and security. AI can be used to anonymize captured drone footage and other information and securely store it to protect patient privacy and comply with data regulations. In another example, AI can assist with training and simulations. AI-driven UAVs 270 simulations can help emergency responders practice different scenarios, improving their skills in managing diverse situations. Overall, AI-integrated UAV 270 technology can enhance the speed, accuracy, and effectiveness of emergency response, leading to better patient outcomes and more efficient resource allocation for ambulance services.

In some aspects, UAV 270 can also assist with rescues of people in the water at a beach, for example. UAV 270 can determine, through AI, whether a person in the water is distressed (e.g., drowning or in need of help). Upon determining that a person in the water is distressed, a coast guard officer, a lifeguard, or any other rescue personnel can be immediately notified by UAV 270. Rescue personnel can communicate with UAV 270, including voice message(s) to UAV 270 which UAV 270 can broadcast to the distressed person. For example, the lifeguard on shore can use their user device (e.g., a mobile device with an associated app to communicate with UAV 270) and say, “Stay calm, help is on the way.” UAV 270 and one or more user devices 240 can utilize bi-directional communication protocols so that remote systems users, such as a lifeguard, can communicate with the identified distressed person.

In some aspects, UAV 270 can also provide aid to the distressed person by providing assistance if struggling to swim. For example, UAV 270 can release or drop an inflation device to the distressed person in the water. The inflation device can have a string or rope attached to UAV 270 and UAV 270 can pull the inflatable device and the person to the shore. In one embodiment, the inflation device can be advantageously formed in the shape of an egg or multiple eggs (the inflation device can also be referred to as a capsule or multiple capsules) which are automatically inflated when travelling to the water by an inflation cartridge. The egg(s) is completely inflated before it hits the water. In some aspects, the egg(s) can be colored either a solid black or a solid blue because solid colors are not easily seen by sharks. A white or yellow stripe may also encircle the eggs to allow the distressed person to more easily see the egg(s). UAV 270 can include a storage compartment to store the inflation device. In some aspects, when UAV 270 detects that it is over a distressed person, a door on the storage compartment can automatically open and egg(s) then exit the storage compartment, automatically inflate, and then impact the water adjacent the distressed person. UAV 270 can also drop a water ski rope with a handle (e.g., stored in the storage compartment) for the distressed person. In some aspects, UAV 270 can travel back and forth so the water ski rope's handle is slightly above the water and can be positioned over the distressed person. The distressed person can then grab the handle and be pulled to safety by UAV 270.

In those examples where the response system is used in various Coast Guard vehicles (e.g., various boats, aircrafts, land vehicles, etc.), AI and UAV 270 integration (e.g., integrating AI into an onboard controller of the UAV 270, system 310, and/or base 280) can bring numerous benefits and assistance to the vehicles and responders in maritime operations. For example, AI can assist with search and rescue efforts. AI-equipped UAVs 270 can cover large search areas quickly, using visual and thermal imaging to spot distressed vessels, debris, and/or individuals in the water. AI algorithms can help identify potential survivors and relay their locations to rescue teams. In another example, AI can assist with surveillance and monitoring. UAVs 270 with AI can monitor maritime activities, identifying unauthorized vessels, detecting illegal fishing, or monitoring marine pollution. AI can analyze the data to highlight suspicious or anomalous behavior. In another example, AI can assist with navigation and collision avoidance. USVs 270 can help ships navigate safely by providing real-time information about water conditions, obstacles, and other vessels. AI can assist in collision avoidance by predicting potential collision paths. In another example, AI can provide environmental monitoring. AI-powered UAVs 270 can monitor ecosystems, detecting changes in water quality, pollution levels, and wildlife behavior. This data can aid in protecting marine environments and responding to environmental disasters. In another example, AI can assist with remote inspections. UAVs 270 can perform remote inspection of ships, offshore, structures, and buoys. AI can analyze the collected data to identify structural issues or maintenance needs. In another example, AI can assist with emergency response. UAVs 270 can deliver emergency supplies such as life jackets or medical equipment, to distresses vessels or individuals in the water, helping to stabilize situations before rescue teams arrive. AI may be used to predict what supplies are needed and can predict and/or recognize when emergency situations arise, thus enabling UAVs 270 to response to emergency situations autonomously. In another example, AI can assist in data collection. UAVs 270 can gather data from remote or hazardous locations, such as oil spills or hazardous material spills, providing real-time information to guide response efforts. AI can be used to identify the hazard (e.g., identify what chemical(s) were spilled) by analyzing various data streams from sensors on UAVs 270. In another example, AI can assist with a communication relay. UAVs 270 can serve as communication relays in remote areas, extending the range of communication for ships and personnel. AI can analyze various factors, such as temperature, humidity, and topographical features of the area, to determine the correct amount, spacing, and arrangement of UAVs 270 to enable communication in a given area and situation. In another example, AI can assist with training and simulations. AI-driven simulations can help Coast Guard personnel practice various scenarios, improving their skills in different maritime situations. AI can be used to predict what the most common situations are but can also identify rare situations that should still be practiced. In another example, AI can assist with environmental compliance. UAVs 270 with AI can monitor shipping lanes for compliance with environmental regulations, ensuring that vessels are adhering to emission and pollution standards. For example, the UAVs 270 may utilize AI to recognize the type of vessel, and then compare the regulations pertaining to that type of vessel with measurements taken by various sensors on the UAVs 270. Incorporating AI into UAV 270 technology empowers the Coast Guard with enhanced situational awareness, quicker response times, and improved decision making capabilities for a wide range of maritime missions.

In those examples where the response system is used to support lifeguards, AI and UAV 270 integration (e.g., integrating AI into an onboard controller of the UAV 270, system 310, and/or base 280) can bring numerous benefits and forms of assistance. For example, AI can assist with swift surveillance. UAVs 270 equipped with AI can quickly survey large stretches of beaches or water bodies, helping lifeguards spot individuals in distress or dangerous situations. The AI can be trained to recognize when swimmers require assistance and/or when swimmers are getting close to a hazard. In another example, AI can assist with water rescues. UAVs 270 can deliver flotation devices and/or lifebuoys to struggling swimmers, providing immediate aid while lifeguards try to reach the scene. AI can predict when a swimmer needs assistance, thus enabling UAVs 270 to autonomously assist swimmers. In another example, AI can provide visibility enhancement. UAVs 270 can provide a bird's-eye view of the water, aiding lifeguards in identifying rip currents, hazardous underwater conditions, and potential hazards. AI may be used to recognize and/or predict dangerous conditions, such as a rip current, and then cause the UAV 270 to notify the lifeguard and/or swimmers. In another example, AI can assist with search and rescue operations. AI-powered UAVs 270 can assist in locating missing swimmers or individuals in difficult-to-reach areas, streamlining search efforts and increasing the chances of successful rescues. In another example, AI can assist with crowd management. UAVs 270 can help lifeguards monitor crowded beaches and identify areas (e.g., using real-time and historical data to make predictions through AI) with higher risks of accidents, enabling proactive measures to ensure visitor safety. In another example, AI can assist with real-time communication. UAVs 270 can act as communication relays, extending the range of communication between lifeguards and remote areas of the beach or water. In another example, AI can help provide safety warnings. UAVs 270 can broadcast safety announcements, weather updates, and warnings to beachgoers, enhancing public awareness and preventing potential dangers. AI can help select and/or predict what warning and/or announcement is appropriate by analyzing various streams of data such as weather data. In another example, AI can assist in providing first aid assistance. UAVs 270 can carry basic medical supplies or automated external defibrillators (AEDs) to provide immediate aid to individuals before lifeguards arrive. AI can recognize and/or predict what medical supplies are needed based off analyzing data, such as video data, of the scene. In another example, AI can assist with water quality monitoring. AI equipped UAVs 270 with sensors can monitor water quality, detecting changes in currents, water temperature, or pollution levels that might affect safety. In another example, AI can assist with training and education. UAVs 270 can capture footage for lifeguard training programs, helping instructors illustrate various scenarios and techniques to enhance skills and preparedness. By combining AI and UAV 270 technology, lifeguards can effectively extend their reach, respond faster to emergencies, and enhance overall safety for beachgoers and swimmers.

The sensors (e.g., LIDAR, thermal, cameras, audio, etc.), various implementations of AI, and various examples of the response system (e.g., as apart of a police vehicle, a firetruck, an ambulance, a security system, etc.) can work together in various ways beyond just a vehicle security and/or emergency response system. For example, LIDAR and other sensors 476 can combine to provide accurate and real-time data about the environment including distances, objects, and obstacles. This information can be used for navigation, autonomous driving, and even advanced mapping for various industries. In another example, AI can process data from LIDAR, cameras, and other sensors 476 to make informed decisions. In autonomous driving, AI may analyze the data to navigate, avoid obstacles, and follow traffic rules. In another example, sensors 476, including LIDAR and camera sensors, can work together to provide a comprehensive view of the surroundings. AI can use this combined data to recognize objects, pedestrians, road signs, and/or other vehicles, enhancing safety in self-driving cars and UAVs 270. In another example, UAVs 270 equipped with LIDAR, cameras, and other sensors 476 can be deployed for tasks such as infrastructure inspection, crop monitoring, and/or disaster assessment. AI can process the collected data to identify potential issues or anomalies. In another example, mobile devices and/or computers can connect to UAVs 270 and/or remote sensors to provide real-time monitoring. This can be used for activities like wildlife tracking, monitoring construction sites, and/or overseeing remote areas. In another example, data collected by LIDAR, cameras, and/or other sensors 476 can be analyzed by AI to extract insights. This information can then be visualized on various devices, helping decision-makers in fields like urban planning, agriculture, and environmental monitoring. In another example, LIDAR-equipped UAVs 270 and ground sensors can collaboratively create detailed 3D maps. AI can assist in stitching these maps together and updating them over time for urban planning, disaster response, or environmental research. In another example, LIDAR, cameras, and/or other sensors 476 data can be used with augmented reality (AR) technology, where mobile devices and/or other computers create interactive AR experiences. This can range from indoor navigation to interactive museum exhibits. In another example, LIDAR-equipped UAVs 270, devices, and/or cameras can aid in remote medical assessments. AI can analyze data and help healthcare professionals make diagnoses, especially when combined with telemedicine platforms. In another example, sensors 476 can integrate with smart cities and IoT. LIDAR, cameras, sensors 476, and AI can be employed in smart city applications. These technologies can contribute to efficient traffic management, waste disposal, energy conservation, etc. By integrating these technologies, solutions can be created that span various industries and applications, enhancing efficiency, safety, and decision-making across a wide range of scenarios.

Turning to FIG. 3, a block diagram of system 310 is shown in communication with network 250, UAV 270, and device 240. In particular, system 310 can be cloud-based and include memory 306 with one or more programs 308. System 310 can include a controller 309 in communication with an alert and response generator 312, response plan database 314, and an event database 316. The term “controller” as used herein encompasses those components utilized to carry-out or otherwise support the processing functionalities of system 310. In some aspects, controller 309 can encompass or may be associated with a programmable logic array, application specific integrated circuit or other similar firmware, as well as any number of individual processors, flight control computers, navigational equipment pieces, computer-readable memories, power supplies, storage devices, interface cards, and other standardized components. In some aspects, controller 309 can include one or more processors in communication with to data storage having stored therein operation instructions for various tasks.

System 310 can be cloud-based and/or be communicatively coupled directly to UAV 270 or indirectly via a network 250. The network 250 can be any combination of a local area network (LAN), an intranet, the Internet, or any other suitable communications network. One or more user devices 240 can also be in communication with system 310 via network 250. The user device 240 can be any suitable user computing device such as a mobile phone, a personal computer, a tablet, a wearable device, an augmented reality interface, or any other suitable user computing device capable of accessing and communicating using local and/or global networks. In some aspects, UAVs 270 may include one or more wireless network transceivers (e.g., a cellular modem, a Bluetooth transceiver, a Wi-Fi transceiver). In some aspects, one or more sensors 476 of UAV 270 as well as other sensors remotely connected thereto (e.g., smart city sensors, other vehicle sensors, etc.) detect activity and the UAV 270, in response to instructions including threat assessment logic from system 310, can perform one or more response operations (e.g., being launched, identifying and/or tracking aspects related to an event of interest, coordinating with other persons such as neighbors, owners, bystanders, police, distracting a suspected intruder, etc.) so as to initiate one or more response operations.

In some aspects, network 250 may be a satellite communication network. UAV 270 may be communicatively coupled to system 310 and/or user devices 240 via network 250 utilizing satellite technology. This ensures stable and consistent communication between UAV 270, system 310, and/or user devices 240 during power outages and in rural areas that may not be covered by other communication technologies such as GSM and CDMA cell networks. Satellite technology may greatly expand the distance that UAV 270 may communicate with other UAVs 270, user devices 240 and/or system 310. Utilizing satellite technology has the additional benefit of allowing UAV 270 to receive emergency signals from satellite phones and/or beacons, such as the devices commonly carried by hikers and backpackers.

In some aspects, UAVs 270 and/or system 310 are configured to help integrate new technologies and pre-existing technologies. For example, automobiles that have built in cameras and computers, and any devices that can utilize Wi-Fi, cellular data, and/or other connections may be configured to access network 250 to be utilized as controllers for UAV 270 and/or system 310.

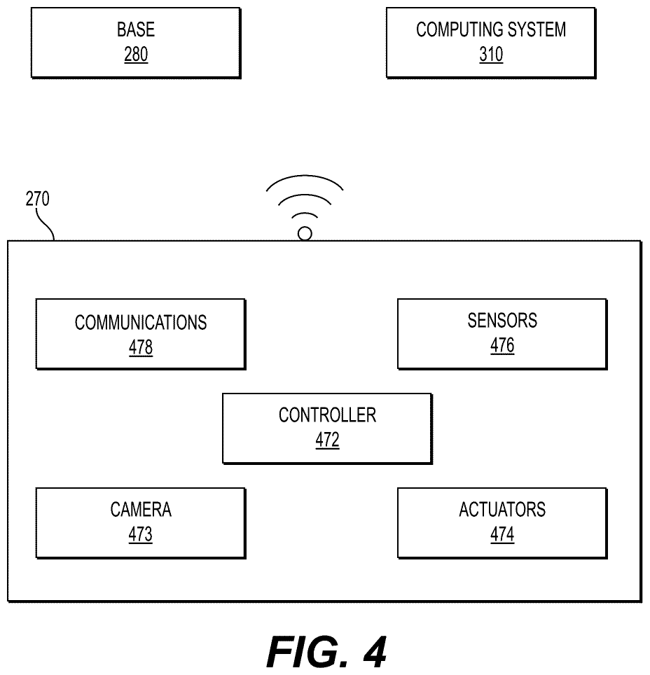

FIG. 4 is a block diagram of an exemplary UAV 270 in communication with base 280 and system 310. UAV 270 may be provided with various levels of control ranging from remote control (e.g., by one or more control centers of database 233, vehicle 330, a UAV base 280 and/or system 310) to autonomous control by onboard controller 472 through AI based on a flight plan provided database 314 and based on sensed information related to event 320 and/or a related area of interest. For example, the onboard controller 472 can autonomously create a flight plan by utilizing an AI model that is fed sensed information such as location of trees, buildings, and other obstacles, but that can also be fed information such as the event requiring the fastest flight plan possible or that a more discrete flight plan is required. Information about the speed or discreteness required may be associated with certain events. In some aspects, the controller 472 may be a UAV flight controller. Communication between UAV 270 and base 280 and/or system 310 may be through communication circuit 478 which has one or more onboard wireless transceivers. Onboard wireless transceivers of circuit 478 can include a radio for remote control (e.g., RF) as well as WiFi, Bluetooth, cellular (e.g., 3G, 4G, 5G, LTE, etc.) and global positioning system (GPS) interfaces. UAV 270 can include an onboard rechargeable power supply (e.g., a direct current battery such as a lithium-ion battery). As previously remarked, UAV 270 can also include one or more sensors 476 and one or more actuators 474. Sensors 476 can include an inertial measurement unit (IMU) having one or more of an accelerometer, a gyroscope, and a magnetometer which may be used to estimate acceleration and speed of UAV 270.

Sensors 476 can also include infrared sensors, thermal sensors, LIDAR sensors, GPS sensors, magnetic sensors, current sensors, and the like. Each of sensors 476 can each generate respective data feeds that, via circuit 478, can be transmitted with system 310 and/or base 280 to further evaluate to identify potential threats and determine related threat response actions by UAVs 270. Actuators 474 can include one or more rotor speed controls depending on how many rotors UAV 270 may have. In some aspects, UAV 270 is equipped with telepresence (e.g., with speaker, microphone, camera, etc.) and a plurality of sensors (e.g., sensors 476) configured for obstacle-avoidance. As used herein, the term “telepresence” means a user, via sensors 476 of a respective UAV 270, remotely interacts with the geolocation associated with the event 320 as opposed to interacting virtually where a user is in a simulated environment. In some aspects, UAV 270 is able to map and identify objects of interest near or otherwise associated with event 320 along a flight operation route using onboard sensors 476 (e.g., one or more high-resolution digital cameras, laser (LiDAR) systems, and/or the like).

Turning back to FIG. 3, controller 309 can receive data from one or more data feeds associated with the surveilled area of event 320 (e.g., data feeds of sensors 476), the data including the event type data used to classify the event and event location data. Controller 309 can determine, by utilizing AI, a match between event data of the one or more data feeds and one or more event types in the event database 316, and determine, by utilizing AI, based on the match, one or more UAV response operations from database 314. In some aspects, controller 309 can receive data from these one or more data feeds associated with event 320 as well as any surrounding area related to an ongoing event (e.g. smart city components, sensors of vehicles, data from other UAVs in use, etc.). In some aspects, controller 309 can share the data with network 250 based on determined geolocation data calculated from the event location data, and use network 250 as an information relay mesh to enhance communication of UAV 270 with one or more command centers (e.g., command centers of database 233). In this respect, network 250 can similarly be in communication with networked crowdsource database 231 so as to dynamically source valuable information from nearby social media users.

In some aspects, controller 309 can receive event location data, determine, by utilizing AI, a direction of movement of any individuals associated with event 320 (e.g., one or more citizens 340, other nearby citizens, one or more suspects (e.g., burglars, assailants, active shooters, etc.)), and other potentially dangerous activities or situations based on the received event location data, determine, from database 314, one or more UAV response operations and related flight patterns, according to one or more criteria, and/or output the selected UAV response action to a UAV flight control system/flight controller (e.g., a control system of UAV 270, a UAV base 280, a vehicle on which UAV 270 can dock, a command center, etc.) operable to cause one or more UAVs to perform a response operation (e.g., navigate to the alert location of event 320). The one or more criteria can include a UAV attendance profile with one or more intruder confrontation actions (e.g., distracting actions such as emitting distracting audio, flashing one or more LEDs, etc.), one or more observation actions (e.g., detecting an event of interest through AI models based on sensed audio feed, sensed video feed, observed changes in environment, etc.), and/or one or more aiding another UAV actions.

In some aspects, the one or more confrontation actions can include an action plan directing the UAV 270 to the alert location of event 320 and/or other area of interest (e.g., launching the UAV 270 from vehicle 330, a trunk, or elsewhere of a vehicle (e.g., from within the cabin via a moonroof and/or through a door window, from a location adjacent the vehicle, etc.)), tracking and/or distracting a citizen or tracked suspect from further activity or to detain them in collaboration with an onboard UAV controller 472 to oppose the determined direction of movement of the individual. In some aspects, the UAV attendance profile includes a flight plan directing the UAV 270 to a location of event 320 or other area of interest to follow a determined direction of movement of the individual. The UAV attendance profile can also include a collaborative flight plan directing the UAV to a location of event 320 or other area of interest associated with the one or more alerts in either aiding the other UAV (e.g., another UAV 270) or to replace a malfunctioning UAV 270 and connect to a command center or other system controller.

In some aspects, the flight plan output to UAV 270 can include instructions to deliver, when at or approximate to the area, one or more on-board effects such as distracting the intruder by emitting soundwaves such as sirens, frequencies in the electro-magnetic spectrum, and reception and onward transmission of data related to the one or more on-board effects. The flight plan output can also include launching a second UAV 270 in another threat response operation to alert people in the vicinity (e.g., a neighbor, a bystander, a police officer, etc.) regarding the detected threat. The flight plan output can also include UAV threat response operation includes launching another UAV 270 to track and identify the location of responding personnel (e.g., a police officer, ambulance, fire response unit, and/or other first responder in the vicinity), travel to the responding personnel, and/or guide the responding personnel to the event 320, any related person, and/or location of interest.

In some aspects, the flight plan output to UAV 270 can include identify the suspect and/or potential witnesses, to follow the suspect, and/or relay to the officer (e.g., to a handheld device used by the officer) and/or base 280 the location and/or identity of the suspect. The base 280 may be a police command center so that other officers may view the occurring event remotely.

In some aspects controller 472 may transmit any of the data received by sensors 476, sensors associated with the surveilled area, and/or smart city component sensors to a command center.

In operation, controller 309 can be configured to manage data streams from each corresponding UAV 270. Such data streams can be used by controller 309 to perform threat assessment logic so as to analyze and identify, by utilizing AI, possible events arising to a predetermined threshold and initiate corresponding response actions in a distributed environment. Examples of such data streams can include audio feeds, video feeds, image feeds, related historical data, and any other feedback received from UAV 270 to identify events of interest (e.g., a conflict arising between a law enforcement officer and a citizen, an intruder breaking into a structure or a vehicle, a fire that is actively burning, an active shooter in a public setting, etc.). In some aspects, data processed by controller 309 can include a status feed of a nearby crowd-sourced data mesh (e.g., from database 233) to identify events of interest so as to identify and/or predict events of interest or threats based thereon.

In some aspects, data processed by controller 309 can include facial recognition data which can be used when implementing an example threat response flight operation by or through operations of UAV 270 to identify the intruder 220 (e.g., through AI facial recognition). In some embodiments, facial recognition may be performed by controller 309 and/or local computing systems of UAV 270. For example, the video, audio, and/or image data feeds from sensors 476 of UAV 270 as well as any other system sensors (e.g., sensors associated with “smart” city components) can be configured to transmit sensed respective data feeds to controller 309. Using threat assessment logic, controller 309 can search and/or crawl connected databases (e.g., law enforcement facial recognition databases) and the internet generally to identify the suspected intruder. For example, controller 309 can search based on facial images of the suspected intruder as well as other potentially identifying information (e.g., AI voice recognition). Once a match is determined, a response flight operation of database 314 can be selected by controller 309.

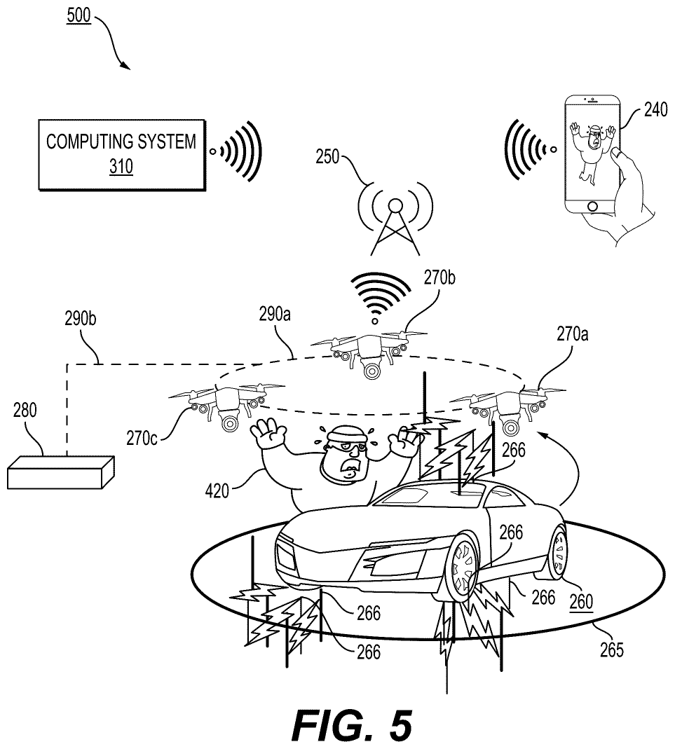

The database 314 can also include a predictive module, utilizing AI, based on the foregoing data feeds, historical data, and/or store one or more predetermined response flight operation plans operable to direct UAV 270 to respond to the detected threat sensed at area 265. Event database 316 can similarly include stored event types both to classify events based on determined matches. In some aspects, the event database 316 can include stored event types to also identify salient or otherwise anomalous events as well as events suitable for response by system 310. In some aspects, the selected flight plan can include a three-dimensional space defined by lateral and longitudinal distance ranges for one or more altitude ranges (e.g., see 290a, 290b of FIG. 5).

In some aspects, generator 312 is configured to classify, by utilizing AI, based on one or more data feeds including event type data and event location data related to event 320, according to characteristics that exceed a predetermined threshold, and then determine, by utilizing AI, based on the classification, one or more alerts and response actions based on the determined one or more event classifications. In some aspects, generator 312 is configured to analyze incoming data and select a UAV threat response operation from any herein discussed databases (e.g., databases 224, 228, 231, 233, 314, 316, etc.), to generate related alerts and response actions using one or more computing methods. Such methods can include, but are not limited to, statistical analysis, autonomous or machine learning, and AI. AI may include, but is not limited to, perception, natural language processing, generative AI, deep learning, artificial neural networks, classifications, clustering, and regression algorithms. By using such computing methods, alert identification and analytics related to event type identification and/or appropriate response actions is substantially improved as is reliability and efficiency and may be continually improved by refining the methods with new data.

In some aspects, a computing system operating one or more of the foregoing computing methods can include a trained machine learning algorithm that takes, as input, any of the herein disclosed data feeds as well as historical databases (e.g., databases 224, 228, 312, 231, 233, 314, 316, facial recognition databases, crime feed databases related to the area associated with event 320, data feeds from vehicle 330, 342, sensors 476, or any other vehicles in the vicinity, data feeds from “smart” city components, etc.), and determines whether one or more salient events or trends are occurring and exceed a predetermined threshold according to event assessment logic. If exceeded, a response by system 310 and/or any corresponding UAVs 270 can be performed. Other historical databases for use can include available meteorological conditions, flight times/schedules of UAVs 270, a charge state of a power source, and/or a UAV tolerance to one or more meteorological conditions.

Many methods may be used to learn which aspects of the foregoing data feeds are salient to the extent one or more alerts are merited, including but not limited to: (1) weak supervision: training a machine learning system (e.g., multi-layer perceptron (MLP), convolutional neural network (CNN), graph neural network, support vector machine (SVM), random forest, etc.) using multiple instance learning (MIL) using weak labeling of the digital image or a collection of images; the label may correspond to the presence or absence of a salient areas; (2) bounding box or polygon-based supervision: training a machine learning system (e.g., region-based CNN (R-CNN), Faster R-CNN, Selective Search) using bounding boxes or polygons that specify the sub-regions of the digital image that are salient for the detection of the presence or absence of one or more markers related to a potential alert; (3) pixel-level labeling (e.g., a semantic or instance segmentation): training a machine learning system (e.g., Mask R-CNN, U-Net, Fully Convolutional Neural Network); and/or (4) using a corresponding, but different digital image that identifies one or more alerts and/or response actions. In other aspects, such computing methods can also be used to analyze the incoming data feeds and select a flight plan from the flight plan database based on the information pertaining to the one or more determined conditions and then output the selected flight plan to the one or more UAVs with determined readiness based on greatest amount of matching of the one or more conditions. In some aspects, based on determining the one or more alerts and/or response actions, such computing methods can also cause a flight control system of UAV 270 to navigate, within a predetermined threshold of time, to a location determined from the received one or more alerts.

In some aspects, generator 312 can generate an alert for transmission to UAV 270 as well as law enforcement, first responders, citizens in the vicinity, and/or one or more user devices 240 in response to an identification of an alert within the area of event 320. In some aspects, generator 312 can predict at least one event characteristic based on salient characteristics and/or trends identified in incoming data from any connected databases (e.g., databases 224, 228, 231, 233, 314, 316, etc.). In some aspects, classifying event 320 can help to provide threat prediction(s) for the area associated event 320 and related responses. A machine learning model associated with generator 312 may have been generated by processing a plurality of training data to predict presence of at least one event characteristic, and the training data may be algorithmically generated based on incoming data from any connected databases (e.g., databases 224, 228, 231, 233, 314, 316, etc.). In turn, generator 312 can be configured to be used to determine a predicted intruder, predicted event, and/or detected event which exceeds a predetermined threat assessment threshold.

For example, generator 312 may predict a future alert based on historical data and incoming data of the foregoing data feeds indicative of a severity or other characteristic satisfying a condition. The generator 312 may include a trained machine learning system having been trained using a learned set of parameters to predict event types, events, and/or intruders. In some embodiments, salient event data indicative of exceeding the predetermined threshold and thus meriting a response can include data indicating a time, a location, an event duration, an event type, and the like. In response to determining that event 320 exceeds the threshold according to threat assessment logic, generator 312 can generate a response, an alert, and/or notification (e.g., to UAV 270 and/or to user device 240) that indicates that a hazard is predicted to impact the equipment or other infrastructure and/or event. In some aspects, generator 312 transmitting the alert can cause, in addition to one or more threat response operations of UAV 270, additional responsive action to occur.

In some aspects, generator 312 can obtain event data from database 316 and then, based on one or more of the foregoing data feeds defining event type data, selectively determine whether to transmit an alert or determine a response associated with the event using the event type data. In some aspects, generator 312 can analyze the predetermined threshold of the threat assessment logic to determine whether the event merits further action based upon a total event score defined in part on the sensed event type data. If the score exceeds a threshold, only then can generator 312 take action such as transmitting a related alert and/or cause responsive action to be performed. The total score can be weighted depending on event type as well as environmental aspects such as current and/or predicted weather (e.g., whether a natural disaster is happening such as an earthquake, hurricane, tornado, or other such extreme event).

According to certain embodiments, system 310 may include a back-end including one or more servers. A server may perform various functions including UAV coordination, logic related to evaluation of data from associated data feeds (e.g., threat assessment logic), as well as storage/processing of captured data (e.g., audio feeds, video feeds, image feeds, etc.). In one example embodiment, the back-end architecture may include, or be in communication with, one or more of a database server, web server, stream server, and/or notify server. In some embodiments, this functionality may be split between multiple servers, which may be provided by one or more discrete providers. In an example embodiment, a web service for hosting computer applications or other cloud computing resource may be dynamically provisioned to match demand and ensure quality of service of system 310.

Referring to FIG. 5, another threat response system 500 is disclosed. System 500 is shown including one or more UAVs 270 used to protect personal property, such as a parked vehicle 260, from a suspected intruder 420. Other types of property that can be protected by system 500 may include person real property (e.g., a house) and/or government owned property (e.g., a police car, firetruck, police station, etc.). The driver and/or the owner of the vehicle 260 and/or a police officer are alerted (e.g., via a user device 240, a text message to a user device 240, an emitted sound or other perceptible output from one of the UAVs 270, etc.) of a suspected threat (e.g., suspected intruder 420) at or near a surveillance target (e.g., a parked automotive vehicle 260). Based on feedback from sensors 476 of UAVs 270, vehicle sensors 266, and any other remotely connected sensors (e.g., sensors of “smart” city components), as soon as the threat is detected, one or more UAVs 270 can be immediately launched to identify the threat and thwart the threat to avoid any theft or damage to the vehicle 260. In examples, the threat may be detected when the suspected intruder 420 makes contact with the vehicle 260 and/or remains within a vicinity (e.g., within 10 feet, within 20 feet, or within 50 feet of the vehicle) of the vehicle for longer than a predetermined amount of time (e.g., 5 seconds, 10 seconds, 30 seconds, 1 minute, 2 minutes, etc.).

In some aspects, the threat may be predicted and an appropriate response action determined by communicating data from sensors 476 of UAVs 270, vehicle sensors 266, and any other remotely connected sensors (e.g., sensors of “smart” city components), to system 310 and/or to response generator 312 within system 310. AI can integrate data from multiple sensors 476 on the UAV 270, such as cameras, sound sensors, and GPS, to provide a comprehensive picture of the security situation. As discussed above with reference to FIG. 3, system 310 may utilize various AI techniques to predict threats and determine response actions. For example, the UAV 270 and/or the system 310 may utilize AI to recognize the voice of the vehicle's 260 owner and/or the owner's authorized users (e.g., friends and family of the owner). Upon recognizing the voice as the owner's voice, the UAV 270 may follow the voice commands of the owner (e.g., to stand down, alert the authorities, to go identify a suspect, etc.). However, if the UAV 270 does not recognize the voice, the UAV 270 may alert the authorities.

In some aspects, UAVs 270 may be configured to secure an area and not only an object. AI can be utilized on UAVs 270 for security purposes in several ways. For example, when used for surveillance and monitoring, UAVs 270 equipped with AI-powered sensors 476 (e.g., cameras) can autonomously monitor large areas, identifying potential security threats such as unauthorized personnel and/or suspicious activities. AI-powered UAVs 270 can autonomously patrol and monitor the perimeter of secure areas, reducing the need for human guards to cover large distances. AI can learn what normal activity looks like in a specific area and identify anomalies that deviate from the norm, allowing security teams to respond to potential breaches or unusual behavior. AI can further learn and recognize patterns of human behavior, helping to differentiate between normal and suspicious activities. In addition, AI algorithms can detect and track objects of interest, such as intruders or vehicles, in real-time using visual and/or thermal imaging, and then providing alters to security personnel. UAVs 270 equipped with facial recognition capabilities can identify individuals on watchlists, enhancing security at events, borders, or crucial infrastructure sites. It is important to note that while AI-equipped UAVs 270 offer numerous benefits for security, there are also ethical and privacy considerations to take into account, especially regarding data collection, retention, and potential misuse of technology.

In some aspects, UAV 270s may be configured to monitor and secure state and/or federal property (e.g., prisons, airports, government buildings, military bases, etc.). UAVs 270 may be configured to integrate into existing government systems, such as controllers, sensors, and/or communication systems. The UAVs 270 of the threat response system may be configured to prevent attacks on state and/or federal property. When used to monitor state, federal, and/or private prisons, UAV 270 may provide surveillance of inmates thereby limiting close contact between inmates and guards. UAV 270 may also monitor the prison and surrounding area to prevent escapes and/or to track escapees. The above features may also be implemented in state, federal, and/or private mental institutions. The response system and UAVs 270 may be made to comply with any state and/or federal requirements (e.g., FAA aviation requirements, airspace requirements, etc.).

In some aspects, UAVs 270 may be configured to assist federal agencies, such as the Border Patrol, to help monitor land and/or water boarders. For example, UAV 270 may monitor large areas to identify and alert agents to illegal entries and/or illegal activities taking place at the boarder. UAV 270 can increase the safety of agents by identifying the event taking place thereby preparing agents and can increase the safety of people in need by notifying agents of their presence and medical condition.

In some aspects, AI can be integrated with UAVs 270 to enhance security in vehicles 260. Some applications include: intrusion detection, AI can analyze data from various sensors 476 to detect unauthorized entry or tampering with the vehicle 260, triggering alarms and/or notifications; behavior analysis, AI can learn normal driving patterns and behaviors of the driver, and flag any anomalies that might indicate a potential threat or impairment; driver monitoring, using facial recognition and gaze tracking, AI can monitor the driver's attention on the road and detect signs of drowsiness or distraction, alerting the driver if necessary; cybersecurity, AI can help detect and prevent cyber attacks on a vehicle's software systems by continuously monitoring for unusual network activities and patterns; autonomous security features, AI-driven autonomous systems can respond to potential dangers, such as sudden obstacles or pedestrians, more effectively than traditional systems; predictive maintenance, AI can analyze vehicle data to predict maintenance needs, preventing breakdowns that can potentially compromise security; smart access control, AI can enable secure access to the vehicle using biometric authentication or mobile apps, reducing the risk of unauthorized access; traffic anomaly detection, AI can analyze traffic patterns and detect unusual congestion or roadblocks, helping drivers avoid potential security risks; emergency response, in the event of an accident, AI can automatically alert emergency services and provide them with crucial information like location and severity of the incident, and; remote monitoring and control, AI-powered systems can allow owners to remotely monitor their vehicles and even disable them in case of theft, increasing the chances of recovery. These applications showcase how AI can play a significant role in enhancing the security of vehicles by leveraging real-time analysis and intelligent decision-making.

In some aspects, AI may be integrated with system 500 and UAVs 270 for various security purposes, both while the vehicle is stationary and while it is in motion. For example, AI algorithms may be used to identify and classify objects and/or people around the vehicle. This is helpful for detecting potential security threats such as unauthorized access or other suspicious activities. The AI may analyze data from various sensors (e.g., cameras, radar, lidar, smart city sensors, etc.) to detect and classify unusual behavior, events, and/or people. For example, the AI may identify if someone is trying to break into the vehicle or if there's an unexpected obstruction in the vehicle's path while driving. The AI may also assist with behavior analysis. For example, while the vehicle is parked, the AI may monitor the behavior of individuals around the vehicle. The AI may recognize patterns, such as loitering and/or repeated approaches to the vehicle, which may indicate a security concern. The AI may also assist with geofencing and alters. For example, the AI may define virtual geographic boundaries (e.g., geofencing) and trigger alerts if the vehicle enters and/or exits specific areas. This is useful for ensuring the vehicle stays within legal limits and can alert authorities and/or the vehicle owner if the vehicle deviates. The AI may also assist with real-time monitoring of the vehicle. For example, while the vehicle is in motion, the AI may provide real-time monitoring of the vehicle's surroundings. The AI may assess traffic conditions, identify potential hazards, and even provide route recommendations to avoid problematic areas. The AI may also be integrated into the vehicle's systems. For example, the AI may be integrated with the vehicle's security system, allowing the AI to lock and/or unlock the vehicle's doors, activate alarms, and/or disable the engine remotely if unauthorized access is detected. The AI may also assist with data analysis and reporting. The AI may collect and analyze data from the UAVs 270 sensors 476 and other sources (e.g., the vehicle's sensors, smart city sensors, etc.). This information can be used to generate reports and insights about security events, helping law enforcement and/or security personnel make informed decisions. For example, the AI may use the information and create reports on the probability of certain events and factors that seem relevant to the probability of said events. The AI may also assist with autonomous UAV 270 control. For example, the AI may enable UAV 270 to operate autonomously, responding to security threats and/or specific commands. The AI may also ensure safe and legal flight paths to avoid collisions with other aircraft and/or restricted airspace. The AI may also be configured to be fully compliant with federal, state, and local laws. The AI may be programmed to operate within legal boundaries, respecting airspace, privacy and surveillance laws. The AI may anonymize data when necessary and only record and/or transmit information that is compliant with the relevant laws and regulations. The AI helps in enhancing the security capabilities of UAV 270 and of the vehicle integrated with UAV 270. The AI may provide advanced monitoring, analysis, and response capabilities to help keep the vehicle and its surroundings secure while adhering to legal and ethical guidelines.

In some aspects, UAVs 270 may be configured to protect property and/or people from other types of hazards. For example, UAVs 270 may be configured to collect data from various sensors of a surveilled area (e.g., gas detectors, radiation detectors, etc.) and use AI to analyze the data for signs of potential hazards.

In some aspects, UAVs 270 may be configured to act as communication relays. For example, UAVs equipped with communication equipment can establish networks in remote or disrupted areas, aiding communication for security teams. AI-equipped UAVs 270 can determine the optimal distribution of UAVs 270 to create a reliable communication network based off sensor 476 data, location data and/or the communication needs of the security teams.

In some aspects, a launched UAV 270 can be configured to identify the intruder 420, aerially chase after the intruder 420 while taking and transmitting event related data (e.g., live video, sound, and/or photos of the intruder 420) to private security, law enforcement including a law enforcement officer in the vicinity, a neighbor, drivers in the area, citizens in the area, and/or owner of the vehicle 260. AI algorithms can enable UAVs 270 to navigate safely, avoiding obstacles and adapting to changing environments, ensuring reliable security patrols.

As an example of using multiple UAVs 270 in response to a detected threat, first UAV 270a can be launched in a response flight operation to identify intruder 420 (e.g., through AI facial recognition) and follow, track, and/or distract the intruder 420 from trying to harm or break into vehicle 260 (e.g., by emitting distracting audio such as a siren or a message announcing that peace officers have been notified, by flashing one or more LEDs, etc.). Second UAV 270b can be simultaneously launched in another response operation to similarly alert people in the vicinity (e.g., a neighbor, one or more citizens in the vicinity such as a bystander, a law enforcement officer, etc.), that a crime or some harmful event related to the detected threat is happening and to stay away or seek help. Third UAV 270c can be simultaneously launched in another response operation to track and identify the location of a law enforcement officer in the vicinity, travel to the officer, and/or guide the officer to vehicle 260 and/or intruder 420. In some aspects, all UAVs 270 can be in communications with one another to help assist in preventing the harm from happening to people and property and to direct the police officer to the intruder 420.

In some embodiments, control base 280 may be adjacent or otherwise nearby surveilled area 265 associated with vehicle 260. In some aspects, base 280 can be positioned in the surveilled area configured as a local control station for UAV 270 to control navigation of UAV 270 and communicate with system 310 (e.g., controller 309 and response generator 312 of system 310) and one or more of plurality of UAVs 270 in a three-dimensional space. In this respect, base 280 can transmit to system 310 and/or UAV 270, data feeds (e.g., audio feeds, video feeds, image feeds, telemetry feeds, etc.) by way of a cloud-based controller server and/or remote computing device-based controller server and then receive from system 310 response operations for UAV 270 after system 310 utilizes all of the received data and determines the response operations through AI models as discussed above with respect to FIG. 3. In some aspects, the one or more threat response operations can include any of the heretofore response operations. In some aspects, one threat response operation can include the UAV 270 following one or more predetermined routes 290a, 290b, 290n, according to a flight plan database. In operation, the controller of system 310 is configured to receive information pertaining to one or more conditions determining readiness of UAV 270 and initiate one or more flight operations based off predictions made by system 310. For example, UAV 270 can be instructed to scan area 265 to verify presence of the suspected intruder 420 or other aspects of an alert. In one predetermined route 290a, UAV 270 can fly about surveilled area 265. In one predetermined route 290b, UAV 270 can surveil area 265 as well as fly to and from control base 280.

In some aspects, a combination of cellphones, vehicle 260 sensors, sensors 476 on UAV 270, speaker systems, AI, and/or other sensors can enable a user to communicate with vehicle 260 and/or intruder 420. For example, vehicle 260 may be equipped with an AI-powered communication system that integrates with the vehicle's 260 cameras, sensors, and speaker system. This system would process data from the cameras and sensors, allowing a user remotely monitor vehicle's 260 surroundings in real-time by communicating all the data to a mobile device. In another example, a mobile app may connect to vehicle's 260 AI-powered communication system. The mobile app may have access to live camera feeds from vehicle's 260 cameras, and receive alerts about security events, and communicate with vehicle 260 remotely. In another example, a UAV 270 equipped with camera(s) may be integrated in the above system. For example, if the AI system detects a potential security threat or intrusion, you can deploy the UAV 270 to get a better view of the situation. The UAV 270 camera feed may be streamed to a mobile device, enabling a user to assess the situation from different angles. In another example, a speaker system of vehicle 260 may be used for two-way communication. If the AI system identifies a potential intruder 420 attempting to break into vehicle 260, the speaker system may be used to communicate with the intruder 420 in real-time. In another example, the mobile app running on a mobile device, may allow a user to establish a connection to the vehicle's 260 speaker system. This would allow a user to talk to the potential intruder 420 directly, issuing warnings or informing them that the authorities have been notified. In another example, the AI system may have predefined responses based on different security scenarios. Recorded messages may be used to warn the intruder 420 that their actions are being monitored, or the AI system may initiate a loud alarm to deter them from continuing. In more serious situations, the AI system may automatically alert local law enforcement agencies while the user is communicating with the intruder 420. This provides an additional layer of security and helps to ensure user and vehicle 260 safety. By integrating these elements, a security system is created that not only allows a user to remotely monitor and communicate with their car, but also proves the capability to interact with potential intruders 420 to deter them and potentially gather information for law enforcement purposes.

In some aspects, the various systems referenced above and below may be integrated with AI. For example, vehicle 260 may be equipped with various sensors (e.g., motion detectors, cameras, biometric sensors, accelerometers, GPS, temperature sensors, gas sensors, etc.). These sensors may continuously monitor the vehicle's 260 surroundings, internal conditions, movement of the vehicle, presence of authorized individuals and/or unauthorized individuals. An AI system would process the data collected by the sensors. The AI system may be integrated into the vehicle 260, UAV 270, and/or a mobile device. The AI system may analyze patters, detect anomalies, recognize authorized users, and make informed decisions based on predefined criteria about potential security threats. For example, it may determine if an intruder 420 is tampering with the vehicle 260, if there is a sudden temperature change, and/or if the vehicle 260 has deviated from its expected path. The AI system may communicate with the UAV 270, mobile device, and other sensors in real-time. The AI system may act as a communication hub. It may establish a connection with the vehicle owner's mobile device using a secure network. This allows the vehicle owner to remotely access the security system's features, receive alerts, monitor live feeds form the vehicle 260 cameras, UAV 270 cameras, check the vehicle's 260 location, and receive various notifications about security events. If the AI detects a potential security threat, suspicious activity, unauthorized access, or anomaly (e.g., sudden change in location or attempted break-in), it may send a signal to the UAV 270 to investigate further, it also may send real-time alerts to connected mobile devices (e.g., push notifications, text messages, emails, etc.). Using connected mobile devices, the vehicle 260 owner may remotely control certain aspects of the vehicle's 260 security system. The owner may activate or deactivate alarms, lock or unlock doors, and/or trigger an immobilization feature to prevent unauthorized movement.

The UAV 270, equipped with its one or more sensors 476, such as cameras, may then be dispatched to the location of interest. The UAV 270 may fly to the specified location and gather more information. The UAV 270 may capture images, video footage, and other relevant data that can help confirm the nature of the threat. The UAV 270 can also use its own sensors 476 to assess the situation from different angles. The data collected by the UAV 270 may be relayed back to the AI system for further analysis. The AI system can then determine if the situation indeed poses a security risk or if it was a false alarm triggered by the sensors. Depending on the outcome, the AI system may take actions such as alerting the vehicle 260 owner, contacting authorities, and/or updating security protocols. Overtime, the AI system can learn from its experiences and improve its decision-making capabilities. It can refine its criteria for identifying threats, minimizing false alarms, and optimizing the deployment of the UAV 270. The AI system may store historical data related to security events. This data can be analyzed to identify trends, improve the AI's detection algorithms, and enhance overall security strategy. The AI system may learn from owner interactions, as well as from the data collected over time. The AI system may adapt its behavior and decision-making processes to better suit the owner's preferences and effectively address potential threats. By integrating these components, a dynamic security system is created where sensors provide real-time data, AI processes the data, and a UAV 270 can be deployed to gather additional data and enhance situational awareness. This approach offers a more robust and adaptable security and/or response solution for vehicles by providing remote access and user control. This comprehensive approach provides both proactive security measures and the ability to respond effectively to various security scenarios.

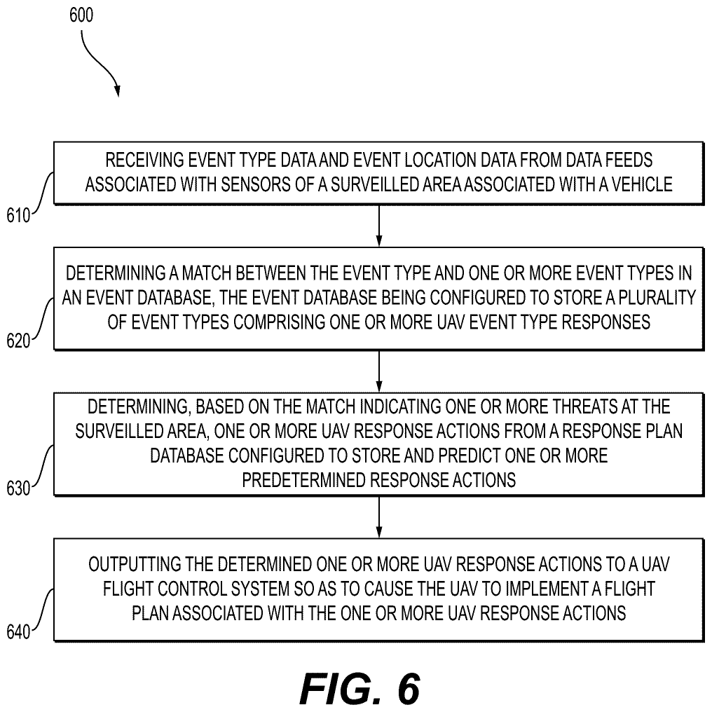

Referring to FIG. 6, a flow diagram of an example method 600 of operating a response system including one or more UAVs is illustrated where a threat at a surveilled area is detected. For example, method 600 (e.g., steps 610 to 640) may be performed automatically in response to the detected threat and/or in response to a request (e.g., from a user). In some aspects, method 600 may be performed automatically in response to a predicted threat. In some aspects, a vehicle associated with the one or more UAVs can include sensors used to detect an intruder, any threat, or harm to the vehicle. In some aspects, such sensors can be used to predict the threat (e.g., based on historical data prior to it happening). In some aspects, such sensors can be used in conjunction with system 310 to predict the threat and determine response actions.

In step 610, the method may include receiving event type data and event location data from data feeds associated with sensors of a surveilled area associated with the vehicle or some other protectible property. In step 620, the method may include determining, by utilizing AI, a match between the event type and one or more event types in an event database, the event database storing a plurality of event types including one or more UAV event type responses. For example, as soon as a threat is detected, one or more UAVs can be immediately launched. One event type response can include one or more UAVs can be launched from the vehicle and/or nearby base in response to detecting the threat. In some aspects, a detected threat event response can include one or more UAVs 270 launching from a trunk and/or elsewhere of the vehicle (e.g., from within the cabin via a moonroof and/or through a door window, from a location adjacent the vehicle, etc.). In step 630, the method may include determining, by utilizing AI, based on the match indicating one or more threats at the surveilled area, one or more UAV threat response operations from a response plan database configured to store and predict one or more predetermined response actions. In step 640, the method may include outputting the determined one or more UAV threat response operations to a UAV flight control system so as to cause the UAV to implement the one or more UAV threat response operations.

In some aspects, step 620 may further include utilizing response generator and/or other components of system 310 to predict the event type.

Some UAV threat response operations might include launching a first UAV to identify the intruder associated with the detected threat (e.g., through AI facial recognition) and follow, track, and/or distract the intruder from trying to harm or break into the vehicle. To identify the intruder, the UAV may transmit video of the intruder to a database containing criminal records. A controller in communication with the UAV and the database may determine whether the intruder has a criminal record by matching the face of the intruder to criminal records within the database. When the intruder has a criminal record, and especially a criminal record relating to vandalism or auto theft, the UAV may transmit an alert to a user device of the vehicle's owner. The alert may include a photo of the intruder and a summary of their criminal records. If there are multiple intruders, the alert may contain photos of each of the intruders and may highlight the intruder(s) with criminal records. Another UAV threat response operation might include launching a second UAV in another threat response operation to similarly alert people (e.g., a neighbor, a bystander, a police officer, etc.) in the vicinity (e.g., within 20 feet of the vehicle, within 100 feet of the vehicle, within 1000 feet of the vehicle, and/or within 1 mile of the vehicle) that a crime or some harmful event related to the detected threat is happening and to stay away or seek help. Another UAV threat response operation includes launching a third UAV to track and identify the location of a police officer in the vicinity, travel to the police officer, and/or guide the police officer to the vehicle and/or the intruder. All UAVs of the response system can be in communication with each other as well as a central controller to facilitate harm prevention by the intruder to the vehicle, other individuals, and nearby property as well as to coordinate with police officer(s) to the intruder. In some aspects, all the UAVs 270 can use AI models in communicating with one another to assess the event and in choosing a response operation.

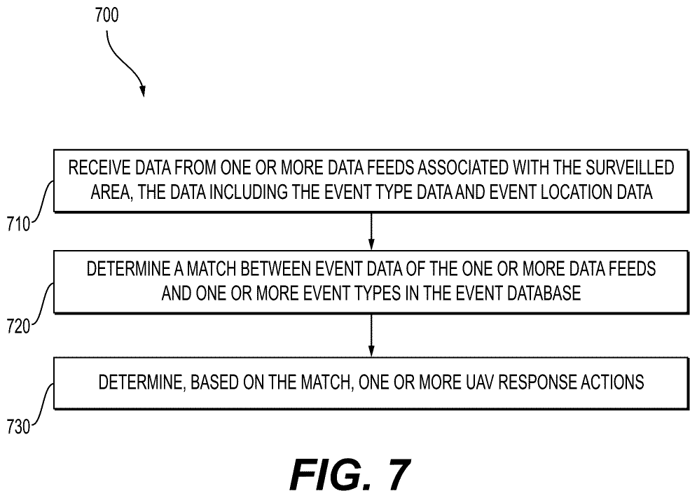

Referring to FIG. 7, a flow diagram of method 700 of operating a controller of a response system for one or more UAVs. For example, method 700 (e.g., steps 710 to 730) may be performed automatically or in response to a request (e.g., from a user). According to one embodiment, the exemplary method 700 may be implemented by a computing system such as a controller of any herein disclosed example that can perform operations of method 700 including one or more of the following steps. In step 710, the method may include receiving data from one or more data feeds associated with the surveilled area, the data including the event type data and event location data. In step 720, the method may include determining a match between event data of the one or more data feeds and one or more event types in the event database. In step 730, the method may include determining, based on the match, one or more UAV threat response operations. According to one or more embodiments, aspects of method 700 may utilize one or more algorithms, architectures, methodologies, attributes, and/or features that can be combined with any or all of the other algorithms, architectures, methodologies, attributes, and/or features. For example, any of the machine learning algorithms and/or architectures (e.g., neural network methods, convolutional neural networks (CNNs), recurrent neural networks (RNNs), etc.) may be trained with any of the training methodologies (e.g., Multiple Instance Learning, Reinforcement Learning, Active Learning, etc.). The description of these terms is merely exemplary and is not intended to limit the terms in any way.

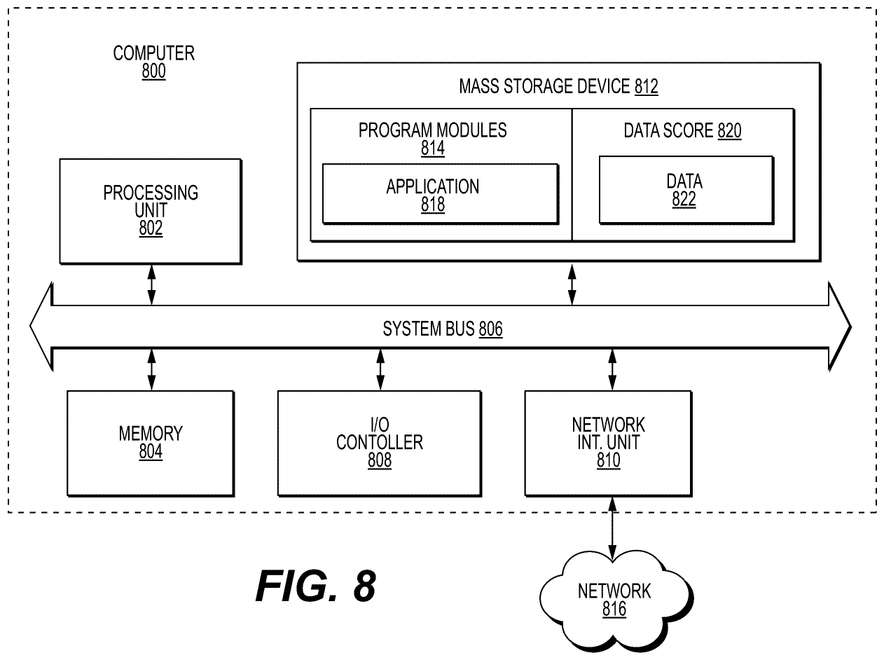

FIG. 8 is a computer architecture diagram showing a general computing system capable of implementing aspects of the present disclosure in accordance with one or more embodiments described herein, such as the computing system of UAV 270, base 280, and system 310. In any of these example implementations, computer 800 of the aforementioned may be configured to perform one or more functions associated with embodiments of this disclosure. For example, the computer 800 may be configured to perform operations in accordance with those examples shown in FIGS. 1 to 5. The computer 800 may be implemented within a single computing device or a computing system formed with multiple connected computing devices. The computer 800 may be configured to perform various distributed computing tasks, in which processing and/or storage resources may be distributed among the multiple devices. The data acquisition and display computer 850 and/or operator console 810 of the system shown in FIG. 8 may include one or more systems and components of the computer 800.

As shown, the computer 800 includes a processing unit 802 (“CPU”), a system memory 804, and a system bus 806 that couples the memory 804 to the CPU 802. The computer 800 further includes a mass storage device 812 for storing program modules 814. The program modules 814 may be operable to analyze data from any herein disclosed data feeds, determine responsive actions, and/or control any related operations (e.g., responsive actions by UAV 270 in response a determined threat at vehicle 260 of area 265). The program modules 814 may include an application 818 for performing data acquisition and/or processing functions as described herein, for example to acquire and/or process any of the herein discussed data feeds. The computer 800 can include a data store 820 for storing data that may include data 822 of data feeds (e.g., data from sensors 476).

The mass storage device 812 is connected to the CPU 802 through a mass storage controller (not shown) connected to the bus 806. The mass storage device 812 and its associated computer-storage media provide non-volatile storage for the computer 800. Although the description of computer-storage media contained herein refers to a mass storage device, such as a hard disk or CD-ROM drive, it should be appreciated by those skilled in the art that computer-storage media can be any available computer storage media that can be accessed by the computer 800.

By way of example and not limitation, computer storage media (also referred to herein as “computer-readable storage medium” or “computer-readable storage media”) may include volatile and non-volatile, removable and non-removable media implemented in any method or technology for storage of information such as computer-storage instructions, data structures, program modules, or other data. For example, computer storage media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 800. “Computer storage media”, “computer-readable storage medium” or “computer-readable storage media” as described herein do not include transitory signals.

According to various embodiments, the computer 800 may operate in a networked environment using connections to other local or remote computers through a network 816 (e.g., previous network 350) via a network interface unit 810 connected to the bus 806. The network interface unit 810 may facilitate connection of the computing device inputs and outputs to one or more suitable networks and/or connections such as a local area network (LAN), a wide area network (WAN), the Internet, a cellular network, a radio frequency (RF) network, a Bluetooth-enabled network, a Wi-Fi enabled network, a satellite-based network, or other wired and/or wireless networks for communication with external devices and/or systems.

The computer 800 may also include an input/output controller 808 for receiving and processing input from any of a number of input devices. Input devices may include one or more of keyboards, mice, stylus, touchscreens, microphones, audio capturing devices, and image/video capturing devices. An end user may utilize the input devices to interact with a user interface, for example a graphical user interface, for managing various functions performed by the computer 800. The bus 806 may enable the processing unit 802 to read code and/or data to/from the mass storage device 812 or other computer-storage media.

The computer-storage media may represent apparatus in the form of storage elements that are implemented using any suitable technology, including but not limited to semiconductors, magnetic materials, optics, or the like. The computer-storage media may represent memory components, whether characterized as RAM, ROM, flash, or other types of technology. The computer storage media may also represent secondary storage, whether implemented as hard drives or otherwise. Hard drive implementations may be characterized as solid state or may include rotating media storing magnetically-encoded information. The program modules 814, which include the data feed application 818, may include instructions that, when loaded into the processing unit 802 and executed, cause the computer 800 to provide functions associated with one or more embodiments illustrated in the figures of this disclosure. The program modules 814 may also provide various tools or techniques by which the computer 800 may participate within the overall systems or operating environments using the components, flows, and data structures discussed throughout this description.

In general, the program modules 814 may, when loaded into the processing unit 802 and executed, transform the processing unit 802 and the overall computer 800 from a general-purpose computing system into a special-purpose computing system. The processing unit 802 may be constructed from any number of transistors or other discrete circuit elements, which may individually or collectively assume any number of states. More specifically, the processing unit 802 may operate as a finite-state machine, in response to executable instructions contained within the program modules 814. These computer-executable instructions may transform the processing unit 802 by specifying how the processing unit 802 transitions between states, thereby transforming the transistors or other discrete hardware elements constituting the processing unit 802.

Encoding the program modules 814 may also transform the physical structure of the computer-storage media. The specific transformation of physical structure may depend on various factors, in different implementations of this description. Examples of such factors may include but are not limited to the technology used to implement the computer-storage media, whether the computer storage media are characterized as primary or secondary storage, and the like. For example, if the computer storage media are implemented as semiconductor-based memory, the program modules 814 may transform the physical state of the semiconductor memory, when the software is encoded therein. For example, the program modules 814 may transform the state of transistors, capacitors, or other discrete circuit elements constituting the semiconductor memory.

As another example, the computer storage media may be implemented using magnetic or optical technology. In such implementations, the program modules 814 may transform the physical state of magnetic or optical media, when the software is encoded therein. These transformations may include altering the magnetic characteristics of particular locations within given magnetic media. These transformations may also include altering the physical features or characteristics of particular locations within given optical media, to change the optical characteristics of those locations. Other transformations of physical media are possible without departing from the scope of the present description, with the foregoing examples provided only to facilitate this discussion.

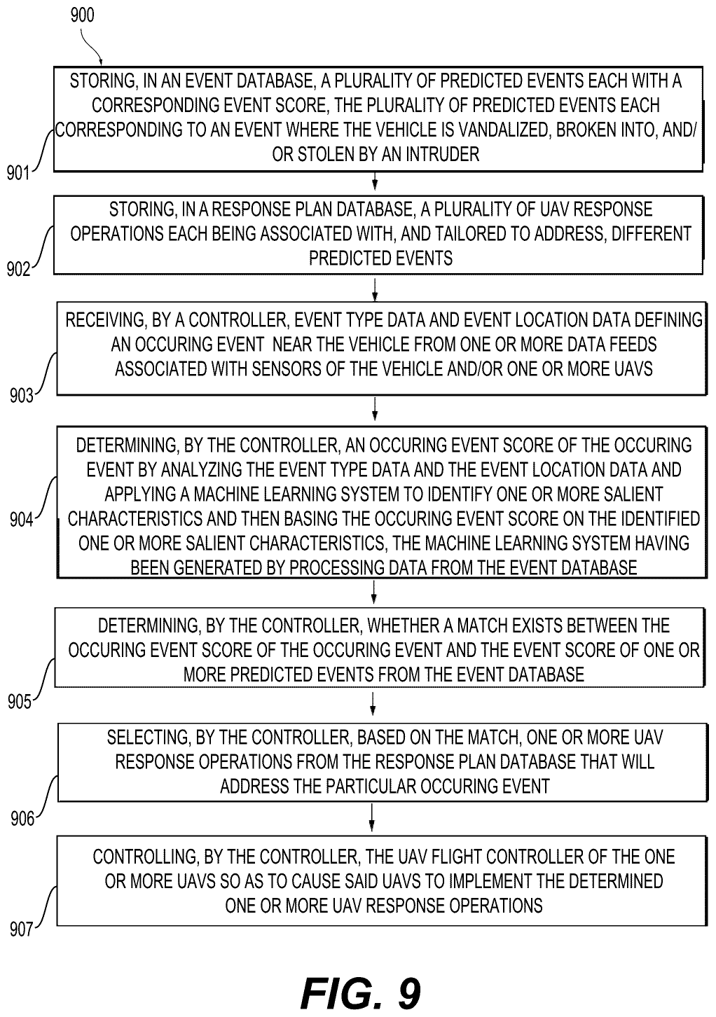

Referring to FIG. 9, a flow diagram of method 900 of operating a controller of a response system for one or more UAVs. For example, method 900 (e.g., steps 901 to 907) may be performed automatically or in response to a request (e.g., from a user). According to one embodiment, the exemplary method 900 may be implemented by a computing system such as a controller of any herein disclosed example that can perform operations of method 900 including one or more of the following steps. In step 901, the method may include storing, in an event database, a plurality of predicted events each with a corresponding event score, the plurality of predicted events each corresponding to an event where the vehicle is vandalized, broken into, and/or stolen by an intruder. In step 902, the method may include storing, in a response plan database, a plurality of UAV response operations each being associated with, and tailored to address, different predicted events. In step 903, the method may include receiving, by a controller, event type data and event location data defining an occurring event near the vehicle from one or more data feeds associated with sensors of the vehicle and/or the one or more UAVs. In step 904, the method may include determining, by the controller, an occurring event score of the occurring event by analyzing the event type data and the event location data and applying a machine learning system to identify one or more salient characteristics and then basing the occurring event score on the identified one or more salient characteristics, the machine learning system having been generated by processing data from the event database. In step 905, the method may include determining, by the controller, whether a match exists between the occurring event score of the occurring event and the event score of one or more predicted events from the event database. In step 906, the method may include selecting, by the controller, based on the match, one or more UAV response operations from the response plan database that will address the particular occurring event. In step 907, the method may include controlling, by the controller, the flight controller of the one or more UAVs so as to cause the one or more UAVs to implement the determined one or more UAV response operations.

According to one or more embodiments, aspects of method 900 may utilize one or more algorithms, architectures, methodologies, attributes, and/or features that can be combined with any or all of the other algorithms, architectures, methodologies, attributes, and/or features. For example, any of the machine learning algorithms and/or architectures (e.g., neural network methods, convolutional neural networks (CNNs), recurrent neural networks (RNNs), etc.) may be trained with any of the training methodologies (e.g., Multiple Instance Learning, Reinforcement Learning, Active Learning, etc.). The description of these terms is merely exemplary and is not intended to limit the terms in any way.

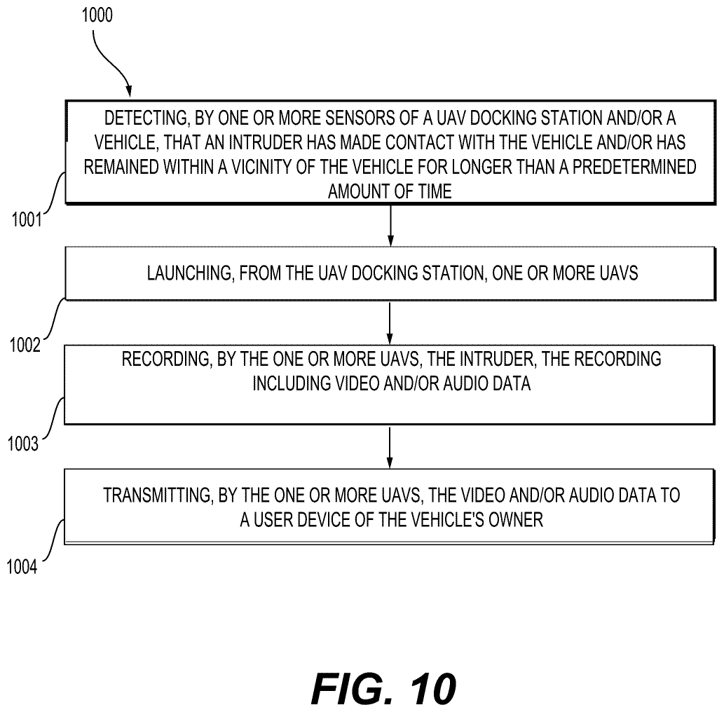

Referring to FIG. 10, a flow diagram of method 1000 of operating a controller of a response system for one or more UAVs. For example, method 1000 (e.g., steps 1001 to 1004) may be performed automatically or in response to a request (e.g., from a user). According to one embodiment, the exemplary method 1000 may be implemented by a computing system such as a controller of any herein disclosed example that can perform operations of method 1000 including one or more of the following steps. In step 1001, the method may include detecting, by one or more sensors of a UAV docking station and/or a vehicle, that an intruder has made contact with the vehicle and/or has remained within a vicinity of the vehicle for longer than a predetermined amount of time. In examples, the vicinity may be within 10 feet of the vehicle, within 50 feet of the vehicle, or other distances shorter than 10 feet or longer than 50 feet. Detecting may be through analyzing audio and/or video data. In examples, the predetermined amount of time may be 10 seconds-10 minutes and/or may be selected by the vehicle owner. In step 1002, the method may include launching, from the UAV docking station, one or more UAVs. The amount of UAVs launched may be based on the amount of intruders in the vicinity of the vehicle. In step 1003, the method may include recording, by the one or more UAVs, the intruder, the recording including video and/or audio data. The recording may include controlling, by a controller, a camera of the one or more UAVs and/or the vehicle to rotate toward the intruder to obtain clear video of the intruder. When there are multiple intruders, multiple cameras of the vehicle and/or the one or more UAVs may be controlled such that at least one camera rotates toward and tracks an intruder of the multiple intruders. In step 1004, the method may include transmitting, by the one or more UAVs, the video and/or audio data to a user device of the vehicle's owner.

According to one or more embodiments, aspects of method 1000 may utilize one or more algorithms, architectures, methodologies, attributes, and/or features that can be combined with any or all of the other algorithms, architectures, methodologies, attributes, and/or features. For example, any of the machine learning algorithms and/or architectures (e.g., neural network methods, convolutional neural networks (CNNs), recurrent neural networks (RNNs), etc.) may be trained with any of the training methodologies (e.g., Multiple Instance Learning, Reinforcement Learning, Active Learning, etc.). The description of these terms is merely exemplary and is not intended to limit the terms in any way.

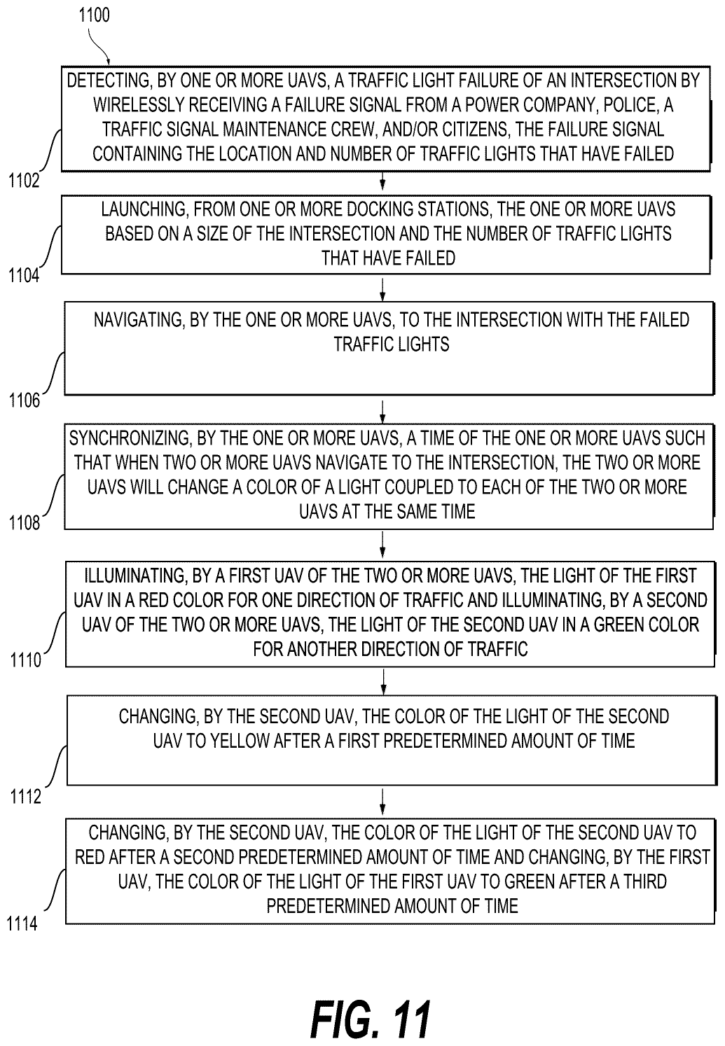

Referring to FIG. 11, a flow diagram of method 1100 of operating a controller of a response system for one or more UAVs. In particular, the controller is able to control one or more UAVs to operate like a traffic light. For example, the one or more UAVs can determine if a traffic light is non-operational, has lost power, or an accident has occurred in the intersection and then fly in the vicinity to direct traffic and activate a light (e.g., a red, yellow, or green light) on the UAV to turn on and off to assist with traffic flow and reduce traffic congestion. As an example, one or more UAV may have red lights on north and south sides and green lights on east and west sides. Therefore, the UAV may change the light color or rotate 90 degrees to change the light color. The lights may be LED lights that can change to different colors.

The method 1100 (e.g., steps 1102 to 1104) may be performed automatically or in response to a request (e.g., from a user). According to one embodiment, the exemplary method 1100 may be implemented by a computing system such as a controller of any herein disclosed example that can perform operations of method 1100 including one or more of the following steps. In step 1102, the method may include detecting, by one or more UAVs, a traffic light failure of an intersection by wirelessly receiving a failure signal from a power company, police, a traffic signal maintenance crew, and/or citizens (e.g., by reporting the traffic light failure through GPS applications on a mobile phone). The failure signal may contain the location and number of traffic lights that have failed. In step 1104, the method may include launching, from one or more docking stations, the one or more UAVs based on a size of the intersection and the number of traffic lights that have failed. For example, a four-way intersection may require more UAVs (e.g., 2, 3, or 4) than a three-way intersection. In step 1106, the method may include navigating, by the one or more UAVs, to the intersection with the failed traffic lights. In step 1108, the method may include synchronizing, by the one or more UAVs, a time of the one or more UAVs such that when two or more UAVs navigate to the intersection, the two or more UAVs will change a color of a light coupled to each of the two or more UAVs at the same time. For example, one may change its light to green and one may change its light to red. Each of the UAVs of the one or more UAVs may have at least one light capable of changing colors (e.g., green, red, and yellow). In examples, each of the one or more UAVs may have three or more lights on one or more sides of the one or more UAVs. In step 1110, the method may include illuminating, by a first UAV of the two or more UAVs, the light of the first UAV in a red color for one direction of traffic and illuminating, by a second UAV of the two or more UAVs, the light of the second UAV in a green color for another direction of traffic. In examples, a single UAV may control the traffic of an intersection by illuminating lights on multiple sides of the single UAV. In step 1112, the method may include changing, by the second UAV, the color of the light of the second UAV to yellow after a first predetermined amount of time. In step 1114, the method may include changing, by the second UAV, the color of the light of the second UAV to red after a second predetermined amount of time and changing, by the first UAV, the color of the light of the first UAV to green after a third predetermined amount of time. The one or more UAVs may continue to cycle through the three colors to safely control traffic through the intersection until the failed traffic lights are fixed.

According to one or more embodiments, aspects of method 1100 may utilize one or more algorithms, architectures, methodologies, attributes, and/or features that can be combined with any or all of the other algorithms, architectures, methodologies, attributes, and/or features. For example, any of the machine learning algorithms and/or architectures (e.g., neural network methods, convolutional neural networks (CNNs), recurrent neural networks (RNNs), etc.) may be trained with any of the training methodologies (e.g., Multiple Instance Learning, Reinforcement Learning, Active Learning, etc.). The description of these terms is merely exemplary and is not intended to limit the terms in any way.

According to certain embodiments, the above-described databases (e.g., databases 224, 228, 231, 233, 314, 316, etc.) may be database servers that store master data, event related data, response plan data, telemetry information, and mission data as well as logging and trace information. The databases may also provide an API to the web server for data interchange based on JSON specifications. In some embodiments, the database may also directly interact with control systems of respective UAVs 270 to control flight operations. According to certain embodiments, the database servers may be optimally designed for storing large amounts of data, responding quickly to incoming requests, having a high availability and historizing master data.

According to certain embodiments, any of the systems of this disclosure may send notifications to a user (e.g., to device 240) including instant messages, SMS messages, and/or other electronic correspondence. If a predetermined condition evidencing a suspected or actual threat at an area (e.g., the area in or around event 320, area 265, etc.), an instant message may be triggered and delivered.

According to certain embodiments, UAVs 270 of this disclosure may automatically start and reschedule repetitive flight plans associated with respect to an area associated with an event of interest. For example, the system may include a scheduler module configured to observe status of each UAV 270, initiate any maintenance operations (e.g., return to a charging dock for charging, clear out cache of memory of UAV 270, update firmware of UAV 270, etc.).

In the description herein, numerous specific details are set forth. However, it is to be understood that embodiments of the present disclosure may be practiced without these specific details. In other instances, well-known methods, structures, and techniques have not been shown in detail in order not to obscure an understanding of this description. References to “one embodiment,” “an embodiment,” “example embodiment,” “some embodiments,” “certain embodiments,” “various embodiments,” etc., indicate that the embodiment(s) of the present disclosure so described may include a particular feature, structure, or characteristic, but not every embodiment necessarily includes the particular feature, structure, or characteristic. Further, repeated use of the phrase “in one embodiment” does not necessarily refer to the same embodiment, although it may.

Throughout the specification and the claims, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form. Accordingly, “a drone” or “the drone” may refer to one or more drones where applicable.

Unless otherwise specified, the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

Certain embodiments of the present disclosure are described above with reference to block and flow diagrams of systems and methods and/or computer program products according to example embodiments of the present disclosure. It will be understood that one or more blocks of the block diagrams and flow diagrams, and combinations of blocks in the block diagrams and flow diagrams, respectively, may be implemented by computer-executable program instructions. Likewise, some blocks of the block diagrams and flow diagrams may not necessarily need to be performed in the order presented, or may not necessarily need to be performed at all, according to some embodiments of the present disclosure.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that may direct a computer or other programmable data processing apparatus to function in a particular manner, such that the instructions stored in the computer-readable memory produce an article of manufacture including instruction means that implement one or more functions specified in the flow diagram block or blocks.

As an example, embodiments of the present disclosure may provide for a computer program product, including a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Various aspects described herein may be implemented using standard programming and/or engineering techniques to produce software, firmware, hardware, and/or any combination thereof to control a computing device to implement the disclosed subject matter. A computer-readable medium may include, for example: a magnetic storage device such as a hard disk, a floppy disk or a magnetic strip; an optical storage device such as a compact disk (CD) or digital versatile disk (DVD); a smart card; and a flash memory device such as a card, stick or key drive, or embedded component. Additionally, it should be appreciated that a carrier wave may be employed to carry computer-readable electronic data including those used in transmitting and receiving electronic data such as streaming video or in accessing a computer network such as the Internet or a local area network (LAN). Of course, a person of ordinary skill in the art will recognize many modifications may be made to this configuration without departing from the scope or spirit of the claimed subject matter.

While certain embodiments of the present disclosure have been described in connection with what is presently considered to be the most practical and various embodiments, it is to be understood that the present disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the present disclosure, including the best mode, and also to enable any person skilled in the art to practice certain embodiments of the present disclosure, including making and using any devices or systems and performing any incorporated methods. The patentable scope of certain embodiments of the present disclosure is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method of operating a response system for a vehicle comprising one or more unmanned aerial vehicles (UAVs) each having a flight controller, the method comprising:
storing, in an event database, a plurality of predicted events each with a corresponding event score, the plurality of predicted events each corresponding to an event where the vehicle is vandalized, broken into, and/or stolen by an intruder;
storing, in a response plan database, a plurality of UAV response operations each being associated with, and tailored to address, different predicted events;
receiving, by a controller, event type data and event location data defining an occurring event near the vehicle from one or more data feeds associated with sensors of the vehicle and/or the one or more UAVs;
determining, by the controller, an occurring event score of the occurring event by analyzing the event type data and the event location data and applying a machine learning system to identify one or more salient characteristics and then basing the occurring event score on the identified one or more salient characteristics, the machine learning system having been generated by processing data from the event database;
determining, by the controller, whether a match exists between the occurring event score of the occurring event and the event score of one or more predicted events from the event database;
selecting, by the controller, based on the match, one or more UAV response operations from the response plan database that will address the particular occurring event; and
controlling, by the controller, the flight controller of the one or more UAVs so as to cause the one or more UAVs to implement the determined one or more UAV response operations.

2. The method of claim 1, wherein the controller, the event database, and/or the response plan database are located remotely from the one or more UAVs, the one or more UAVs being configured to communicate wirelessly with the controller, the event database, and/or the response plan database.

3. The method of claim 1, wherein the controller is located within the one or more UAVs, the controller being configured to communicate wirelessly with the event database and the response plan database.

4. The method of claim 1, wherein one of the plurality of UAV response operations comprise:
launching the one or more UAVs from a docking station within a trunk of the vehicle to identify an intruder associated with the occurring event;
causing the one or more UAVs to follow and/or distract the intruder;
alerting, by the one or more UAVs, one or more persons in a vicinity of the intruder regarding the occurring event and the intruder; and
tracking and/or identifying, by the one or more UAVs, a location of a responding officer in the vicinity.

5. The method of claim 1, wherein one of the plurality of UAV response operations comprise:
launching the one or more UAVs from a docking station within a trunk of the vehicle to identify an intruder associated with the occurring event;
instructing, by the one or more UAVs, the intruder to step away from the vehicle; and
sending, by the one or more UAVs, an alert to a user device to inform the vehicle's owner of the occurring event and giving the vehicle's owner an option of alerting police.

6. The method of claim 5, wherein the alert to the user device includes a text message and/or a video feed.

7. The method of claim 1, wherein receiving the event type data and the event location data from the one or more data feeds includes receiving data from one or more sensors installed on the one or more UAVs, the vehicle, and/or a surveilled area.

8. The method of claim 1, wherein one of the plurality of UAV response operations comprise:
launching the one or more UAVs from a docking station within a trunk of the vehicle to identify an intruder associated with the occurring event;
receiving, by the one or more UAVs, a voice sample of the intruder;
determining, by the one or more UAVs, whether the voice of the intruder matches a voice of the vehicle's owner by applying a voice recognition machine learning system to compare the voice sample of the intruder to stored voice samples of the vehicle's owner, the voice recognition machine learning system having been generated by processing a plurality of voice samples of the vehicle's owner; and
alerting, by the one or more UAVs, the vehicle's owner when the voice of the intruder does not match the voice of the vehicle's owner.

9. The method of claim 1, wherein:
the machine learning system is configured to identify and/or determine a distance between the intruder and the vehicle, a weapon and/or tool in a hand of the intruder, and/or contact between the intruder and the vehicle by analyzing video data from the one or more UAVs, and
the one or more salient characteristics include the distance between the intruder and the vehicle, whether a weapon and/or tool is in the hand of the intruder, and/or whether the intruder made contact with the vehicle.

10. The method of claim 1, wherein:
the one or more UAVs are located in a docking station within a trunk of the vehicle,
the docking station is configured to receive energy from the vehicle and to supply energy to the one or more UAVs by charging a battery of the one or more UAVs, and
the controller is configured to open the trunk to allow the one or more UAVs to launch from the trunk and to close the trunk after the one or more UAVs are launched from the trunk.

11. A method of operating a vehicle protection system comprising one or more unmanned aerial vehicles (UAVs), the method comprising:
detecting, by one or more sensors of a UAV docking station and/or a vehicle, that an intruder has made contact with the vehicle and/or has remained within a vicinity of the vehicle for longer than a predetermined amount of time;
launching, from the UAV docking station, the one or more UAVs;
recording, by the one or more UAVs, the intruder, the recording including video and/or audio data; and
transmitting, by the one or more UAVs, the video and/or audio data to a user device of the vehicle's owner.

12. The method of claim 11, wherein the one or more UAVs each have a flight controller, the method further comprising:
storing, in an event database, a plurality of predicted events each with a corresponding event score, the plurality of predicted events each corresponding to an event where the vehicle is vandalized, broken into, and/or stolen by the intruder;
storing, in a response plan database, a plurality of UAV response operations each being associated with, and tailored to address, different predicted events;
receiving, by a controller, event type data and event location data defining an occurring event near the vehicle from one or more data feeds associated with sensors of the vehicle and/or the one or more UAVs;
determining, by the controller, an occurring event score of the occurring event by analyzing the event type data and the event location data and applying a machine learning system to identify one or more salient characteristics and then basing the occurring event score on the identified one or more salient characteristics, the machine learning system having been generated by processing data from the event database;
determining, by the controller, whether a match exists between the occurring event score of the occurring event and the event score of one or more predicted events from the event database;
selecting, by the controller, based on the match, one or more UAV response operations from the response plan database that will address the particular occurring event; and
controlling, by the controller, the flight controller of the one or more UAVs so as to cause the one or more UAVs to implement the determined one or more UAV response operations.

13. The method of claim 12, wherein:
the machine learning system is configured to identify a distance between the intruder and the vehicle, a weapon and/or tool in a hand of the intruder, and/or contact between the intruder and the vehicle by analyzing video data from the one or more UAVs, and
the one or more salient characteristics include the distance between the intruder and the vehicle, whether a weapon and/or tool is in the hand of the intruder, and/or whether the intruder made contact with the vehicle.

14. The method of claim 12, wherein:
the docking station is located within a trunk of the vehicle,
the docking station is configured to receive energy from the vehicle and to supply energy to the one or more UAVs by charging a battery of the one or more UAVs, and
the controller is configured to open the trunk to allow the one or more UAVs to launch from the trunk and to close the trunk after the one or more UAVs are launched from the trunk.

15. The method of claim 12, wherein one of the plurality of UAV response operations comprise:
identifying, by the one or more UAVs, the intruder;
following, by the one or more UAVs, the intruder; and
relaying, to an officer, a location and/or the identity of the intruder by transmitting the location and/or the identity of the intruder to a hand held device of the officer.

16. The method of claim 12, wherein one of the plurality of UAV response operations comprise:
receiving, by the one or more UAVs, a voice sample of the intruder;
determining, by the one or more UAVs, whether the voice of the intruder matches a voice of the vehicle's owner by applying a voice recognition machine learning system to compare the voice sample of the intruder to stored voice samples of the vehicle's owner, the voice recognition machine learning system having been generated by processing a plurality of voice samples of the vehicle's owner; and
alerting, by the one or more UAVs, the vehicle's owner when the voice of the intruder does not match the voice of the vehicle's owner.

17. The method of claim 12, wherein the controller is configured to receive data from the one or more sensors of the one or more UAVs and/or the vehicle, wherein data from the one or more sensors include a video feed, an audio data feed, and/or a UAV location feed.

18. The method of claim 17, wherein the controller is configured to transmit the received data from the one or more sensors of the one or more UAVs and/or the vehicle to a police command center to enable officers to remotely view the occurring event.

19. The method of claim 12, wherein one of the plurality of UAV response operations comprise:
causing, by the controller, the one or more UAVs to distract the intruder;
alerting, by the one or more UAVs, one or more persons in a vicinity of the intruder regarding the occurring event and the intruder; and
tracking and/or identifying, by the one or more UAVs, a location of a responding officer in the vicinity.

20. The method of claim 11, further comprising:
transmitting, by the one or more UAVs, video data of the intruder to a database containing criminal records;
receiving, by the one or more UAVs, an indication from the database whether the intruder has criminal records; and
transmitting, by the one or more UAVs, a photo of the intruder and/or an alert to a user device of the vehicle's owner, the alert detailing the criminal records of the intruder.
